(19) United States
(12) Patent Application Publication
(10) Pub. No.: US 2009/0040451 A1
(43) Pub. Date: Feb. 12, 2009

(54) CYCLIC OLEFIN RESIN FILM, POLARIZING PLATE, AND LIQUID CRYSTAL DISPLAY

(75) Inventor: Masaya Suzuki, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/817,451

(22) PCT Filed: Sep. 28, 2006
(86) PCT No.: PCT/JP2006/319918

§ 371 Date: Aug. 30, 2007

(30) Foreign Application Priority Data
Sep. 30, 2005 (JP) 2005-288704

(51) Int. Cl. C09K 19/22; C08K 3/34; C08K 3/36

(52) U.S. Cl. 349/183; 524/442; 524/493; 264/299

(57) ABSTRACT

A cyclic olefin resin film having a water vapor transmission rate of 200 to 400 g/m²/24 hrs at 40° C. and 90% RH and containing 0.03% to 1.0% by weight of particles having an in-film average particle size of 3.0 μm or smaller. The film shows good adhesion to a polarizer, exhibits favorable moisture permeability helping reduce deterioration of a polarizing plate, and hardly varies in optical characteristics with changes in ambient temperature and humidity. The film provides an excellent polarizing plate and liquid crystal display.

### TECHNICAL FIELD

This invention relates to a cyclic olefin resin film. In particular, it relates to a cyclic olefin resin film suitable as various functional films including a retardation film or a viewing angle compensation film used in liquid crystal displays (LCDs) and an anti-reflection film used in plasma displays; a polarizer protective film, a polarizing plate, and an image display device.

### BACKGROUND ART

A polarizing plate is generally composed of a polarizer made of a polyvinyl alcohol (PVA) film having iodine or a dichroic dye adsorbed and oriented therein and a protective film disposed on both sides of the polarizer. Cellulose triacetate is widely used with preference as a polarizer protective film to provide a polarizing plate because of its advantages such as toughness, flame retardancy, and high optical isotropy (i.e., low retardation). An LCD is basically composed of a liquid crystal cell and a polarizing plate. With respect to TN mode TFT-LCDs, today's mainstream of LCDs, an LCD of high display qualities has been realized by inserting an optical compensation film between a polarizing plate and a liquid crystal cell as described in JP-A-8-50206. Stricter display performance is required of the latest LCDs and, to meet the need, it has been demanded to further reduce variations of optical characteristics with changes in ambient temperature and humidity.

Cyclic olefin resin films are less hygroscopic and less moisture permeable than cellulose triacetate films and have been attracting attention as films showing less variations of optical characteristics with changes in ambient temperature and humidity. Cyclic olefin resin films fabricated by melt film formation or solvent casting have been under development for applications in polarizing plates and LCDs. JP-A-2005-43740 and JP-A-2002-114827 disclose an optical film comprising a cyclic olefin ring-opening polymerization polymer, and JP-A-2001-272534 discloses an optical film comprising a cyclic olefin addition polymerization polymer.

However, cyclic olefin resins, which are hydrophobic, are less adhesive to a PVA-based polarizer, which is hydrophilic, than commonly employed cellulose triacetate.

JP-A-2001-272534 discloses a cyclic olefin resin film with low moisture permeability. A hydrophilic PVA-based polarizer essentially has high hygroscopicity. Where a low-moisture permeable cyclic olefin resin film is used as a protective film on both sides of such a hygroscopic polarizer, the water vapor emitted from the polarizer is confined within the polarizer, and the polarizer per se increases in temperature and humidity when placed under high temperature conditions. As a result, the polarizing plate would undergo noticeable changes in light transmittance, degree of polarization, and the like and prove less reliable.

In addition, using a low-moisture permeable cyclic olefin resin film as a protective film to make a polarizing plate involves manufacturing and fabrication problems. That is, a prolonged drying time is needed to remove water content in the manufacture of a polarizing plate, and the resulting polarizing plate needs a long period of conditioning before fabrication or assembly.

Although conventionally used cellulose triacetate films have sufficient moisture permeability for allowing water vapor to escape from the PVA polarizer, they themselves undergo slight changes in optical characteristics with changes in ambient temperature and humidity.

### DISCLOSURE OF THE INVENTION

An object of the invention is to provide a film having good adhesion to a polarizer and favorable moisture permeability helping reduce deterioration of a polarizing plate and hardly varying in optical characteristics with changes in ambient temperature and humidity.

Another object of the invention is to provide an excellent polarizing plate and LCD by using the film.

The invention provides in its first aspect a cyclic olefin resin film. The cyclic olefin resin film has a water vapor transmission rate of 200 to 400 g/m²/24 hrs at 40° C. and 90% RH and contains 0.03% to 1.0% by weight of particles having an average particle size of 3.0 μm or smaller in the film.

The first aspect of the invention includes embodiments in which

(1) The cyclic olefin resin film contains at least one cyclic olefin resin selected from the group consisting of (A-1), (A-2), and (A-3) below.
(A-1): an addition copolymer containing at least one repeating unit represented by formula (I) and at least one repeating unit represented by formula (II).
(A-2): an addition (co)polymer containing at least one repeating unit represented by formula (II).
(A-3): a ring opening (co)polymerization polymer containing at least one repeating unit represented by formula (III).

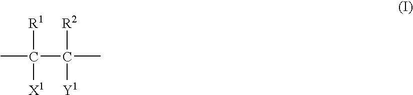

wherein X¹ and Y¹ each represent a hydrogen atom, a hydrocarbon group having 1 to 10 carbon atoms, a halogen atom, a halogen-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ or —(CH₂)ₙW; or X¹ and Y¹ are taken together to form (—CO)₂O or (—CO)₂NR¹⁵, R¹¹, R¹², R¹³, R¹⁴, and R¹⁵ each represent a hydrogen atom or a hydrocarbon group having 1 to 20 carbon atoms; Z represents a hydrocarbon group or a halogen-substituted hydrocarbon group; W represents SiR¹⁶ₚD₃₋ₚ; R¹⁶ represents a hydrocarbon group having 1 to 10 carbon atoms; D represents a halogen atom, —OCOR¹⁶ or —OR¹⁶; p represents an integer of 0 to 3; and n represents an integer of 0 to 10.

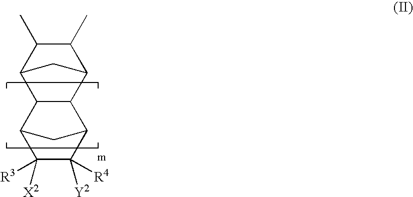

wherein m represents an integer of 0 to 4; R³ and R⁴ each represent a hydrogen atom or a hydrocarbon group having 1 to 10 carbon atoms, X² and Y² each represent a hydrogen atom, a hydrocarbon group having 1 to 10 carbon atoms, a halogen atom, a halogen-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ or —(CH₂)ₙW; or X² and Y² are taken together to form (—CO)₂O or (—CO)₂NR¹⁵; R¹¹, R¹², R¹³, R¹⁴, and R¹⁵ each represent a hydrogen atom or a hydrocarbon group having 1 to 20 carbon atoms; Z represents a hydrocarbon group or a halogen-substituted hydrocarbon group; W represents SiR¹⁶ₚD₃₋ₚ; R¹⁶ represents a hydrocarbon group having 1 to 10 carbon atoms; D represents a halogen atom, —OCOR¹⁶ or —OR¹⁶, p represents an integer of 0 to 3; and n represents an integer of 0 to 10.

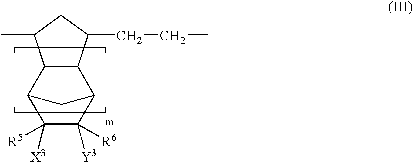

wherein m represents an integer of 0 to 4; R⁵ and R⁶ each represent a hydrogen atom or a hydrocarbon group having 1 to 10 carbon atoms, X³ and Y³ each represent a hydrogen atom, a hydrocarbon group having 1 to 10 carbon atoms, a halogen atom, a halogen-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ or —(CH₂)ₙW; or X³ and Y³ are taken together to form (—CO)₂O or (—CO)₂NR¹⁵; R¹¹, R¹², R¹³, R¹⁴, and R¹⁵ each represent a hydrogen atom or a hydrocarbon group having 1 to 20 carbon atoms; Z represents a hydrocarbon group or a halogen-substituted hydrocarbon group; W represents SiR¹⁶ₚD₃₋ₚ; R¹⁶ represents a hydrocarbon group having 1 to 10 carbon atoms; D represents a halogen atom, —OCOR¹⁶ or —OR¹⁶; p represents an integer of 0 to 3; and n represents an integer of 0 to 10.
(2) The particles are silicon dioxide particles or silicone particles.

The invention also provides in its second aspect a process of producing the cyclic olefin resin film disclosed. The process includes the steps of casting a dope containing a cyclic olefin resin and fine particles on a support, peeling the cast film from the support, and drying the cast film.

The second aspect of the invention includes a preferred embodiment in which the process further includes the step of stretching the cast film peeled off the support.

The invention also provides in its third aspect a polarizing plate having a polarizer and a protective film on both sides of the polarizer. At least one of the protective films is the cyclic olefin resin film of the present invention.

The invention also provides in its fourth aspect an LCD having at least one polarizing plate. The at least one polarizing plate is the polarizing plate of the invention.

The fourth aspect of the invention includes preferred embodiments in which:

(i) The LCD is a VA mode LCD.
(ii) The LCD is a TN mode LCD in which at least one of the protective films has an in-plane retardation Re(630) of 15 nm or less and a thickness direction retardation Rth(630) of 40 to 120 nm both at 25° C. and 60% RH and has a discotic liquid crystal layer superposed thereon. The figures in the parentheses following Re or Rth are wavelength λ nm at which Re or Rth is measured (hereinafter the same).
(iii) The LCD is a VA mode LCD in which at least one of the protective films has an in-plane retardation Re(630) of 15 nm or less and a thickness direction retardation Rth(630) of 120 to 300 nm both at 25° C. and 60% RH and has a rod-like liquid crystal layer superposed thereon.
(iv) The LCD is an OCB mode LCD in which at least one of the protective films has an in-plane retardation Re(630) of 30 to 70 nm and a thickness direction retardation Rth(630) of 120 to 300 nm both at 25° C. and 60% RH and has a discotic liquid crystal layer superposed thereon.

The above-described drying load problems involved in the manufacturing and fabrication of a polarizing plate having a polarizer and a protective film on at least one side of the polarizer can be alleviated by using, as the protective film, the cyclic olefin resin film of the invention having moderate moisture permeability and containing fine particles. The cyclic olefin resin protective film has high adhesion to a polarizer, which contributes to the improvement of yield and process freedom in polarizing plate fabrication, and provides a superior polarizing plate with reduced deterioration in light transmittance, polarization degree, and the like. Furthermore, the cyclic olefin resin film undergoes extremely small changes in optical characteristics out of various properties possessed by itself with changes in ambient humidity and therefore provides a polarizing plate the extinction ratio of which is little dependent on temperature and humidity.

### BEST MODE FOR CARRYING OUT THE INVENTION

The present invention relates in its first aspect to a cyclic olefin resin film (hereinafter also referred to as a cyclic polyolefin film) having a water vapor transmission rate of 200 to 400 g/m²/24 hrs at 40° C. and 90% RH and containing 0.03% to 1.0% by weight of particles having an average particle size of 3.0 μm or smaller in the film as a matting agent.

The term “average particle size in the film” as used herein with respect to the matting agent (particles) means an average particle size of the matting agent present in the film and on the film surface. The particle size or average particle size in the film and on the film surface will hereinafter be referred to as “in-film particle size” or “in-film average particle size”, respectively. The average particle size is an average of circle equivalent diameters of 100 particles, whether agglomerates or non-agglomerates, chosen from the surface and cut area of the film under SEM observation and/or TEM observation. A circle equivalent diameter is calculated by measuring the projected area of a particle on a micrograph and then back-calculating the diameter of a circle with the same area. In the measurement, an SEM and/or TEM micrograph of the matting agent at a magnification of 5000× was used. The in-film average particle size of the matting agent is a parameter decisive of the surface roughness of the film. Where the matting agent is cohesive, the in-film average particle size does not mean an average primary particle size.

Where the matting agent is cohesive, the in-film average particle size means an average agglomerate size (average secondary particle size). When a film containing the particles is formed by solvent casting using a dope having the particles dispersed therein or by applying a matting agent dispersion to a base film, the average agglomerate size can be controlled by adjusting the dispersed particle size. Where the matting agent is noncohesive particles, the average particle size denotes an average of primary particle sizes.

The cyclic polyolefin film has a water vapor transmission rate of 200 to 400 g/m²/24 hrs, preferably 250 to 390 g/m²/24 hrs, more preferably 300 to 380 g/m²/24 hrs, at 40° C. and 90% RH. For use as a protective film of a polarizing plate, the cyclic polyolefin film has a water vapor transmission rate of 200 g/m²/24 hrs or more so as to facilitate escape of the water content from a polarizer in polarizing plate fabrication. The polarizer is thus prevented from having its water content confined therein, and the polarizing plate is thereby prevented from undergoing reduction of performance due to deterioration of the polarizer. With that water vapor transmission rate, the cyclic polyolefin film exhibits good adhesion to a hydrophilic polarizer typified by a PVA film and hardly separates therefrom. This is advantageous for securing the durability of the resulting polarizing plate and for achieving good yield in punching the polarizing plate. The cyclic polyolefin film has a water vapor transmission rate of 400 g/m²/24 hrs or less so as to protect the polarizer from the influences of changes in environmental conditions such as humidity. With the thus limited moisture permeability, the film serves for the functions as a protective film protecting the inside polarizer from deterioration.

The water vapor transmission rate is determined as follows. A sample having a measuring area of 70 mm in diameter is conditioned at 40° C. and 90% RH for 24 hours in a water vapor permeability tester (KK-709007 available from Toyo Seiki Seisaku-sho, Ltd.). The water content per unit area (g/m²) of the sample is measured in accordance with JIS Z0208. The water vapor transmission rate is obtained from the difference between the weight before conditioning and the weight after conditioning.

Desirable optical characteristics of the cyclic polyolefin film depend on the use of the film as will be described later with reference to specific applications.

In what follows, the cyclic olefin resin will also be referred to as a cyclic polyolefin. The terminology “cyclic polyolefin” denotes a polymer resin having a cyclic olefin structure. Examples of polymer resins having a cyclic olefin structure include (1) norbornene polymers, (2) monocyclic olefin polymers, (3) cyclic conjugated diene polymers, (4) vinyl alicyclic hydrocarbon polymers, and (5) hydrogenation products of the polymers (1) to (4).

Of the cyclic olefin resins particularly preferred is at least one member selected from the group consisting of (A-1) an addition copolymer containing at least one repeating unit represented by formula (I) and at least one repeating unit represented by formula (II), (A-2) an addition (co)polymer containing at least one repeating unit represented by formula (II), and (A-3) a ring opening (co)polymerization polymer containing at least one repeating unit represented by formula (III):

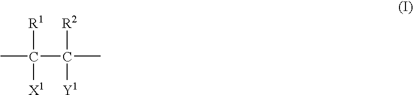

wherein X¹ and Y¹ each represent a hydrogen atom, a hydrocarbon group having 1 to 10 carbon atoms, a halogen atom, a halogen-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ or —(CH₂)ₙW; or X¹ and Y¹ are taken together to form (—CO)₂O or (—CO)₂NR¹⁵, R¹¹, R¹², R¹³, R¹⁴, and R¹⁵ each represent a hydrogen atom or a hydrocarbon group having 1 to 20 carbon atoms; Z represents a hydrocarbon group or a halogen-substituted hydrocarbon group; W represents SiR¹⁷ₚD₃₋ₚ; R¹⁶ represents a hydrocarbon group having 1 to 10 carbon atoms, D represents a halogen atom, —OCOR¹⁶ or —OR¹⁶; p represents an integer of 0 to 3; and n represents an integer of 0 to 10.

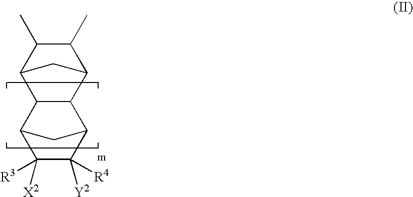

wherein m represents an integer of 0 to 4, R³ and R⁴ each represent a hydrogen atom or a hydrocarbon group having 1 to 10 carbon atoms; X² and Y² each represent a hydrogen atom, a hydrocarbon group having 1 to 10 carbon atoms, a halogen atom, a halogen-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ or —(CH₂)ₙW; or X² and Y² are taken together to form (—CO)₂O or (—CO)₂NR¹⁵; R¹¹, R¹², R¹³, R¹⁴, and R¹⁵ each represent a hydrogen atom or a hydrocarbon group having 1 to 20 carbon atoms, Z represents a hydrocarbon group or a halogen-substituted hydrocarbon group; W represents SiR¹⁶ₚD₃₋ₚ; R¹⁶ represents a hydrocarbon group having 1 to 10 carbon atoms; D represents a halogen atom, —OCOR¹⁶ or —OR¹⁶; p represents an integer of 0 to 3; and n represents an integer of 0 to 10

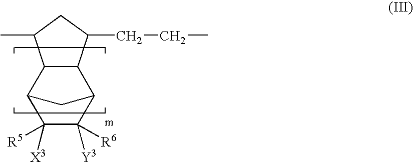

wherein m represents an integer of 0 to 4; R⁵ and R⁶ each represent a hydrogen atom or a hydrocarbon group having 1 to 10 carbon atoms; X³ and Y³ each represent a hydrogen atom, a hydrocarbon group having 1 to 10 carbon atoms, a halogen atom, a halogen-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ or —(CH₂)ₙW; or X³ and Y³ are taken together to form (—CO)₂O or (—CO)₂NR¹⁵; R¹¹, R¹², R¹³, R¹⁴, and R¹⁵ each represent a hydrogen atom or a hydrocarbon group having 1 to 20 carbon atoms; Z represents a hydrocarbon group or a halogen-substituted hydrocarbon group; W represents SiR¹⁶ₚD₃₋ₚ; R¹⁶ represents a hydrocarbon group having 1 to 10 carbon atoms; D represents a halogen atom, —OCOR¹⁶ or —OR¹⁶; p represents an integer of 0 to 3; and n represents an integer of 0 to 10.

Of the above cyclic olefin resins more preferred are those in which all of, or part of, the repeating units constituting the resin molecule contain at least one polar substituent selected from a halogen atom, a halogen-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW, and (—CO)₂O and (—CO)₂NR¹⁵ both formed by connecting X¹ and Y¹, X² and Y², or X³ and Y³. Even more preferred are those in which all of, or part of, the repeating units constituting the resin molecule contain at least one polar substituent selected from —(CH₂)ₙCOOR¹¹ and —(CH₂)ₙOCOR².

Incorporating a functional group with high polarity into all or part of the substituents X¹, X², X³, Y¹, Y², and Y³ is effective to provide an optical film having an increased thickness direction retardation (Rth) and enhanced capability of developing in-plane retardation (Re). A film having high capability of developing Re increases its Re value on being stretched in a step of the film formation.

The norbornene addition (co)polymers are disclosed in JP-A-10-7732, JP-T-2002-504184, US 2004229157A1 and WO2004/070463A1. They are obtained by addition polymerization of a norbornene polycyclic unsaturated compound. According to need, a norbornene polycyclic unsaturated compound can be addition copolymerized with ethylene, propylene, butene, a conjugated diene such as butadiene or isoprene, a non-conjugated diene such as ethylidenenorbornene, acrylonitrile, acrylic acid, methacrylic acid, maleic anhydride, an acrylic ester, a methacrylic ester, maleimide, vinyl acetate, vinyl chloride, etc Appear™ 300 from Ferrania S.p.A is an example of commercially available norbornene addition (co)polymers.

The norbornene polymer hydrogenation products are obtained by addition polymerization or ring-opening metathesis polymerization of a polycyclic unsaturated compound followed by hydrogenation as taught in JP-A-1-240517, JP-A-7-196736, JP-A-60-26024, JP-A-62-19801, JP-A-2003-1159767, and JP-A-2004-309979.

The cyclic olefin resin film may contain various additives as appropriate to the use, such as deterioration inhibitors, anti-UV agents, agents for retardation (optical anisotropy) control, fine particles, release aids, and IR absorbers. The additives can be added to a solution of the cyclic polyolefin (so-called dope) that can be used to form the cyclic olefin resin film of the invention at any stage of dope preparation. The additives may be each either solid or oily. In other words, the additives are not limited by their melting point or boiling point. For example, a UV absorber (anti-UV agent) whose melting point is below 20° C. and another UV absorber whose melting point is above 20° C. may be used in combination. The same applies to a combination of deterioration inhibitors. Useful IR absorbing dyes (IR absorbers) are described, e.g., in JP-A-2001-194522. The additives may be added at any stage during dope preparation. Otherwise, a step of adding additives may be provided as a final stage of dope preparation. The amount of each additive is not particularly limited as long as the expected effect is manifested. Where the cyclic polyolefin film has a multilayer structure, the kinds and amounts of the additives may differ between layers.

The fine particles that are present in the cyclic olefin resin film of the invention will then be described. As previously referred to, the fine particles are also called a matting agent. It is known that a film is given improved slip or anti-blocking properties by surface roughening, which can be achieved by incorporating fine particles of an organic substance and/or an inorganic substance, namely matting. It suffices for the particles to exist in the cyclic olefin resin film. The particles may exist on at least one side of the film. The existence of the particles secures markedly improved adhesion between the cyclic olefin film and a polarizer during fabrication of the polarizing plate.

When the cyclic olefin resin film is a transparent optical film applied to a polarizer to make a polarizing plate, it is desirable to decrease the haze by reducing the matte effect thereby to achieve clarity. Taking this into account, the in-film average particle size and amount of the particles favorable to that application are as follows.

The matting agent used in the invention which is an inorganic substance preferably has an in-film average particle size of 0.05 to 3.0 μm, more preferably 0.05 to 1.0 μm, even more preferably 0.08 to 0.50 μm, most preferably 0.10 to 0.30 μm. The matting agent can have its in-film average particle size regulated as desired by adjusting the average primary particle size of the particles and carrying out dispersing operation as described infra. It is preferred for the inorganic matting gent to have an average primary particle size of 0.005 to 0.5 μm, more preferably 0.01 to 0.2 μm.

Where in using polymer fine particles as a matting agent, it is possible to make a film having a desired refractive index by a proper choice of the polymer. Moreover, because polymer particles are highly compatible with the cyclic olefin resin, there is obtained a film with controlled haze, refraction, and scatter. It is therefore recommended to use polymer particles whose size is larger than the preferred size of the inorganic matting agent.

Specifically, the polymer matting agent preferably has an in-film average particle size of 0.1 to 3.0 μm, more preferably 0.15 to 2.0 μm, even more preferably 0.2 to 1.0 μm.

As previously defined, the term “in-film average particle size” as used for the matting agent means an average particle size of the matting agent present in the film (inclusive of the particles existing on the film surface). Irrespective of whether the matting agent is agglomerates or non-agglomerates, the average particle size is an average of circle equivalent diameters of 100 particles chosen from the surface and cut area of the film under SEM observation and/or TEM observation A circle equivalent diameter is calculated by measuring the projected area of a particle on a micrograph and then back-calculating the diameter of a circle with the same area.

Where the matting agent is cohesive, the average particle size means an average agglomerate size (average secondary particle size). When the film containing the particles is formed by solvent casting, the in-film average agglomerate size can be controlled by adjusting the dispersed particle size by dispersing operation hereinafter described. Where the matting agent is noncohesive particles, the average particle size denotes an average of primary particle sizes.

The amount of the fine particles in the film ranges from 0.03% to 1.0% by weight irrespective of the shape (whether spherical or irregular) and the kind (whether inorganic or organic). The amount is preferably 0.05% to 0.6% by weight, more preferably 0.08% to 0.4% by weight.

The cyclic olefin resin film containing the matting agent particles preferably has a haze of 4.0% or less, more preferably 2.0% or less, even more preferably 1.0% or less. In order to reduce the haze, it is desirable that the matting agent particles be thoroughly dispersed to reduce agglomerates and/or that the particles be used only in a skin layer of a multilayered film (hereinafter described). Haze is measured with a hazemeter (ND-1001DP manufactured by Nippon Denshoku Kogyo KK).

Dispersing the matting agent can be carried out by any commonly employed method with no restriction. Useful dispersing apparatus include those using a grinding media, such as an attritor, a ball mill, a sand mill, and a Dynomill, and those using no grinding media, such as an ultrasonic disperser, a centrifugal disperser, and a high-pressure disperser. Using the dispersing apparatus described is not essential but recommended.

The method of incorporating the matting agent into the film is not particularly limited and includes a solvent casting technique using a dope containing a polymer and the matting agent and a method by applying a matting agent dispersion to a base film separately prepared. The latter method is preferred from the standpoint of ease of control of the matting agent distribution on the film surface. The former method is preferred from economical viewpoint. A layered solvent casting technique described later is also a preferred method that can control the matting agent distribution on the film surface.

The “polymer” as referred to above is the above-described cyclic olefin resin or other polymers.

Where a film is formed by solvent casting using a dope containing the polymer and the matting agent, the matting agent may be dispersed when a solution of the polymer is prepared, or a dispersion of the matting agent may be mixed into the polymer solution immediately before casting. In dispersing the matting agent in the polymer solution, a surface active agent or a polymer may be added in a small amount as a dispersion aid Apart from the above methods, a separately prepared film of the matting agent may be provided on a film. In this case, a binder is preferably used to form the matting layer film. The binder may be either lipophilic or hydrophilic. Useful lipophilic binders include known thermoplastic resins, thermosetting resins, radiation curing resins, reactive resins, and mixtures thereof. It is preferred to use binder resins having a Tg of 80° to 400° C., more preferably 120° to 350° C., and a weight average molecular weight of 10,000 to 1,000,000, more preferably 10,000 to 500,000.

The thermoplastic resins include vinyl copolymers, such as vinyl chloride-vinyl acetate copolymers, vinyl chloride-vinyl acetate-vinyl alcohol-(maleic acid and/or acrylic acid) copolymers, vinyl chloride-vinylidene chloride copolymers, vinyl chloride-acrylonitrile copolymers, and ethylene-vinyl acetate copolymers, cellulose derivatives, such as nitrocellulose, cellulose acetate propionate, and cellulose acetate butyrate; cyclic olefin resins, acrylic resins, polyvinyl acetal resins, polyvinyl butyral resins, polyester polyurethane resins, polyether polyurethane resins, polycarbonate polyurethane resins, polyester resins, polyether resins, polyamide resins, amino resins, rubber-like resins, such as styrene-butadiene resins and butadiene-acrylonitrile resins; silicone resins, and fluororesins.

Where the matting agent is incorporated into the cyclic olefin resin film by wet coating, the matting agent is preferably applied by traditional known coating techniques using, for example, die coaters including an extrusion coater and a slide coater, roll coaters including a forward roll coater, a reverse roll coater, and a gravure coater, a rod coater, and a blade coater. The coating temperature is preferably 10° to 100° C., more preferably 20° to 80° C., to avoid deformation of the substrate (base film) or denaturation of the coating. The coating speed, which is decided as appropriate to the viscosity of the coating and the coating temperature, preferably ranges 10 to 100 m/min, more preferably 20 to 80 m/min.

The coating layer containing the matting agent is formed by applying a coating prepared by dispersing the matting agent in an appropriate organic solvent to a base film containing the cyclic olefin resin, followed by drying. The matting agent may be added to the coating in the form of a dispersion. Useful dispersing media include water, alcohols (e.g., methanol, ethanol, and isopropyl alcohol), ketones (e.g., acetone, methyl ethyl ketone, and cyclohexanone), esters (e.g., methyl, ethyl, propyl or butyl ester of acetic acid, formic acid, oxalic acid, maleic acid or succinic acid), aromatic hydrocarbons (e.g., benzene, toluene, and xylene), and amides (e.g., dimethylformamide, dimethylacetamide, and n-methylpyrrolidone).

A film-forming binder can be used in forming a matting agent layer. Examples of such a binder include known thermoplastic resins, thermosetting resins, radiation curing resins and reactive resins, mixtures of these resins, and hydrophilic binders such as gelatin.

In case of using a cohesive matting agent whichever of the above methods of incorporating the matting agent into the film is chosen, the in-film average particle size of the matting agent in the resulting cyclic olefin resin film can be controlled by varying the average primary particle size, the amount of the matting agent to be added, and various dispersing conditions including the kind and amount of the dispersing medium, the method of dispersing, the type and scale of the dispersing apparatus, the dispersing time, the energy per unit time the dispersing apparatus gives to the dispersion, the method of mixing, the amount of the binder to be added, the order of addition, and the amount of materials put into the dispersing apparatus.

In using a noncohesive matting agent, too, it is desirable to control the above-described dispersing conditions in case unexpected agglomeration of the particles occurs.

The cyclic olefin resin film having the fine particles incorporated therein preferably has a coefficient of dynamic friction of 0.8 or smaller, more preferably 0.5 or smaller. With this frictional coefficient, the cyclic olefin resin film can be wound into a neat roll without skewing or wrinkling in the course of film formation and subsequent fabrication operation. With no nonuniform tension due to skewing or wrinkling imposed to the film, the film is prevented from developing unexpected nonuniform optical characteristics. The coefficient of dynamic friction can be measured using a steel ball in accordance with the method specified in JIS or ASTM.

The particulate matting agent that can be used in the invention include inorganic compounds and polymers. The composition of the particles is not particularly limited, and two or more kinds of the matting agents can be used in combination. The inorganic compounds include silicon compounds, silicon dioxide, silicone, barium sulfate, colloidal manganese, strontium barium sulfate, titanium oxide, zinc oxide, aluminum oxide, barium oxide, zirconium oxide, strontium oxide, antimony oxide, tin oxide, tin oxide/antimony, calcium carbonate, talc, clay, calcined kaolin, calcined calcium silicate, hydrated calcium silicate, aluminum silicate, magnesium silicate, and calcium phosphate. Further included are synthetic silica obtained in a wet process or by gelation of silicic acid and titanium dioxide (inclusive of rutile and anatase) produced from titanium slug and sulfuric acid. Coarse inorganic matter having a particle size, e.g., of 20 μm or greater can be used as pulverized and classified (by vibration filtration or air classification). Of the above-described inorganic compounds, silicon compounds and zirconium oxide are preferred. Silicon compounds are more preferred to provide a film with reduced turbidity and haze. There are many commercially available products of fine silicon dioxide particles having the surface treated with an organic substance. Such surface-treated silicon dioxide particles are particularly preferred to provide a film with reduced surface haze. Examples of the organic substance that can be used to treat the silicon dioxide particles include halosilanes, alkoxysilanes, silazanes, and siloxanes. Fine silicone particles are preferably those having a three-dimensional network structure and more preferably those having an alkyl group (e.g., methyl) bonded thereto by surface treatment.

Examples of commercially available fine silicon dioxide particles are Aerosil R972 R974, R812, 200, 300, R202, OX50, and TT600 from Nippon Aerosil Co., Ltd.; Excelica SE-5, SE-8, SE-15, SE-5V, SE-8V, SE-15K, UF-320, UF-310, and UF-305 (from Tokuyama Corp.).

Examples of commercially available silicones are XC99-A8808, Tospearl 120, 130, 145, and 200B (all available from GE Toshiba Silicones Co., Ltd.).

The polymers that can be used as particulate matting agent include fluororesins, such as polytetrafluoroethylene and tetrafluoroethylene-perfluoroalkyl vinyl ether copolymer, cellulose acetate, polystyrene, polypropylene, polymethyl methacrylate, polypropyl methacrylate, polymethyl acrylate, polyethylene carbonate, polyamide, chlorinated polyether, and starch. Pulverized and classified products of these polymer particles are also used. Polymers prepared by suspension polymerization, spherical polymers obtained by spray drying or dispersing, or inorganic compounds can be used.

Particles prepared from polymers of one or more monomer compounds described below by various means are also useful. Examples of the monomer compounds include:

(1) Acrylic esters, methacrylic esters, itaconic diesters, crotonic esters, maleic diesters, and phthalic diesters with methyl, ethyl, propyl, isopropyl, butyl, hexyl, 2-ethylhexyl, 2-chloroethyl, cyanoethyl, 2-acetoxyethyl, dimethylaminoethyl, benzyl, cyclohexyl, furfuryl, phenyl, 2-hydroxyethyl, 2-ethoxyethyl, glycidyl, ω-methoxypolyethylene glycol (number of moles added: 9), etc.
(2) Vinyl esters, such as vinyl acetate, vinyl propionate, vinyl butyrate, vinyl isobutyrate, vinyl caproate, vinyl chloroacetate, vinyl methoxyacetate, vinyl phenylacetate, vinyl benzoate, and vinyl salicylate.
(3) Olefins, such as dicyclopentadiene, ethylene, propylene, 1-butene, 1-pentene, vinyl chloride, vinylidene chloride, isoprene, chloroprene, butadiene, and 2,3-dimethylbutadiene.
(4) Styrenes, such as styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, trifluoromethylstyrene, and methyl vinylbenzoate.
(5) Acrylamides, such as acrylamide, methylacrylamide, ethylacrylamide, propylacrylamide, butylacrylamide, tert-butylacrylamide, phenylacrylamide, and dimethylacrylamide.
(6) Methacrylamides, such as methacrylamide, methylmethacrylamide, ethylmethacrylamide, propylmethacrylamide, and tert-butylmethacrylamide.
(7) Allyl compounds, such as allyl acetate, allyl caproate, allyl laurate, and allyl benzoate.
(8) Vinyl ethers, such as methyl vinyl ether, butyl vinyl ether, hexyl vinyl ether, methoxyethyl vinyl ether, and dimethylaminoethyl vinyl ether.
(9) Vinyl ketones, such as methyl vinyl ketone, phenyl vinyl ketone, and methoxyethyl vinyl ketone.
(10) Heterocyclic vinyl compounds, such as vinylpyridine, N-vinylimidazole, N-vinyloxazolidone, N-vinyltriazole, and N-vinylpyrrolidone.
(11) Unsaturated nitriles, such as acrylonitrile and methacrylonitrile.
(12) Polyfunctional monomers, such as divinylbenzene, methylenebisacrylamide, and ethylene glycol dimethacrylate.
(13) Acrylic acid, methacrylic acid, itaconic acid, maleic acid, itaconic acid monoalkyl esters (e.g., ethyl itaconate); maleic acid monoalkyl esters (e.g., methyl maleate); styrenesulfonic acid, vinyltoluenesulfonic acid, vinylsulfonic acid, acryloyloxyalkylsulfonic acids (e.g., acryloyloxymethylsulfonic acid); methacryloyoxyalkylsulfonic acids (e.g., methacryloyloxyethylsulfonic acid); acrylamidoalkylsulfonic acids (e.g., 2-acrylamido-2-methylethanesulfonic acid), methacrylamidoalkylsulfonic acids (e.g., 2-methacrylamido-2-methylethanesulfonic acid); and acryloyloxyalkyl phosphates (e.g., acryoyloxyethyl phosphate), and their salts with an alkali metal (e.g., Na or K) or an ammonium ion.
(14) Crosslinking monomers described in U.S. Pat. Nos. 3,459,790, 3,438,708, 3,554,987, 4,215,195 and 4,247,673, and JP-A-57-205735, such as N-(2-acetoacetoxyethyl)acrylamide and N-(2-(2-acetoacetoxyethoxy)ethyl)acrylamide.

These monomer compounds may be homopolymerized to provide homopolymers which are converted into particles, or two or more of them may be copolymerized to provide copolymers which are converted into particles. Preferred of them are acrylic esters, methacrylic esters, vinyl esters, styrenes, and olefins. In addition, particles having a fluorine atom or a silicon atom as described in JP-A-62-14647, JP-A-62-17744, and JP-A-62-17743 may be used.

Of the polymers of the monomer compounds described above, preferred are polystyrene, polymethyl(meth)acrylate, polyethyl acrylate methyl methacrylate-methacrylic acid (95/5 by mole) copolymer, styrene-styrenesulfonic acid (95/5 by mole) copolymer, polyacrylonitrile, and methyl methacrylate-ethyl acrylate-methacrylic acid (50/40/10 by mole) copolymer.

Polymer particles having a reactive group (particularly a gelatin-reactive group) as disclosed in JP-A-64-77052 and EP307855 can also be used. A large amount of a group dissolving under an alkaline or acidic condition may be incorporated to polymer particles.

Of the polymers described, preferred are fluororesins, such as polytetrafluoroethylene and tetrafluoroethylene-perfluoroalkyl vinyl ether copolymer, polyamide, polypropylene, and chlorinated polyether. Fluororesins such as polytetrafluoroethylene are preferred for their solvent resistance and capability of forming fine particles of 0.5 μm or smaller, which is advantageous for providing a film with reduced haze Polyamides are preferred for having a very close refractive index to that of the cyclic olefin resin, which offers advantage to reduce the haze of the film.

Commercially available polytetrafluoroethylene products that can be used include Lubron L-2, L-5 and L-5F (from Daikin Industries, Ltd.). Commercially available polyamide products that can be used include SP-500 (from Toray Industries, Inc.).

Of the preferred inorganic matting agents (silicon dioxide, silicone, and titanium dioxide) and the preferred organic matting agents (fluororesins, e.g., polytetrafluoroethylene, polyamide, polypropylene, and chlorinated polyether), more preferred are silicon dioxide, silicone, and fluororesins, e.g., polytetrafluoroethylene. Silicon dioxide and silicone that are surface-treated with an organic substance are even more preferred.

When the matting agent particles are added in the form of a dispersion, it is desirable to filter the dispersion. It is preferred that the dispersion after filtration, without being stored in a stock tank, be delivered through a conduit to an in-line mixer without using a delivery pump, where it is mixed up with a cyclic olefin resin solution that has similarly been delivered through a separate conduit. By so doing, formation of agglomerates due to disruption of the flow of liquids or use of a delivery pump can be averted. A filter for filtering the matting agent dispersion is preferably placed immediately upstream of the in-line mixer. Filter medias include a granular packed bed, wire cloth (particularly Dutch weave wire cloth, woven cloth, filter paper, and a perforated plate (inclusive of a microporous plate). The filter media to be used is not particularly limited as long as it is serviceable for a long period of time at a constant filtration efficiency. Metallic filter medias, particularly a stainless steel filter media, are preferred in view of solvent resistance and durability. The absolute filtration rating of the filter media preferably ranges from 10 to 100 μm, more preferably from 30 to 60 μm, which enables long-term use with a constant filtration efficiency.

The cyclic olefin resin film of the invention preferably contains a known deterioration inhibitor (antioxidant). Useful antioxidants include phenol or hydroquinone antioxidants, such as 2,6-di-t-butyl-4-methylphenol, 4,4′-thiobis-(6-t-butyl-3-methylphenol), 1,1′-bis(4-hydroxyphenyl)cyclohexane, 2,2′-ethylenebis(4-ethyl-6-t-butylphenol), 2,5-di-t-butylhydroquinone, and pentaerythritol tetrakis[3-(3,5-di-t-butyl-4-hydroxyphenyl)propionate]; and phosphorus antioxidants, such as tris(4-methoxy-3,5-diphenyl)phosphite, tris(nonylphenyl)phosphite, tris(2,4-di-t-butylphenyl)phosphite, bis(2,6-di-t-butyl-4-methylphenyl)pentaerythritol diphosphite, and bis(2,4-di-t-butylphenyl)pentaerythritol diphosphite.

The antioxidant is preferably added in an amount of 0.05 to 5.0 parts by weight per 100 parts by weight of the cyclic polyolefin.

The cyclic olefin resin film preferably contains a UV absorber for protecting a polarizing plate, an LCD, etc. from deterioration by ultraviolet light. In order to achieve UV absorption while securing liquid crystal display quality, UV absorbers that effectively absorb UV light of 370 nm or shorter wavelength but absorb little visible light of 400 nm or longer wavelength are preferred. Suitable UV absorbers for use in the invention include hindered phenol compounds, hydroxybenzophenone compounds, benzotriazole compounds, salicylic ester compounds, benzophenone compounds, cyanoacrylate compounds, and nickel complex compounds. Examples of the hindered phenol compounds are 2,6-di-t-butyl-p-cresol, pentaerythritol tetrakis[3-(3,5-di-t-butyl-4-hydroxyphenyl)propionate], N,N′-hexamethylenebis(3,5-di-t-butyl-4-hydroxy-hydrocinnamide), 1,3,5-trimethyl-2,4,6-tris(3,5-di-t-butyl-4-hydroxybenzyl)benzene, and tris-(3,5-di-t-butyl-4-hydroxybenzyl)isocyanurate Examples of the benzotriazole compounds are 2-(2′-hydroxy-5′-methylphenyl)benzotriazole, 2,2-methylenebis(4-(1,1,3,3-tetramethylbutyl)-6-(2H-benzotriazol-2-yl)phe nol), 2,4-bis(n-octylthio)-6-(4-hydroxy-3,5-di-t-butylanilino)-1,3,5-triazine, triethylene glycol bis[3-(3-t-butyl-5-methyl-4-hydroxyphenyl)propionate], N,N′-hexamethylenebis(3,5-di-t-butyl-4-hydroxy-hydrocinnamide), 1,3,5-trimethyl-2,4,6-tris(3,5-di-t-butyl-4-hydroxybenzyl)benzene, 2-(2′-hydroxy-3′,5′-di-t-butylphenyl)-5-chlorobenzotriazole, 2-(2′-hydroxy-3′,5′-di-t-amylphenyl)-5-chlorobenzotriazole, 2,6-di-t-butyl-p-cresol, and pentaerythritol tetrakis[3-(3,5-di-t-butyl-4-hydroxyphenyl)propionate] The UV absorber is preferably added in an amount of 1 ppm to 1.0% by weight, more preferably 10 to 1000 ppm, based on the cyclic polyolefin.

Many surface active agents are found to produce a pronounced effect to reduce release resistance of the cyclic polyolefin film. Surface active agents effective as a release agent include phosphoric esters, carboxylic acids and salts thereof, sulfonic acids and salts thereof, and sulfuric esters. Fluorine-containing surface active agents derived from these surface active agents by replacing part of the hydrogen atoms bonded to the hydrocarbon chain with a fluorine atom are also effective. The following is a list of useful release agents.
RZ-1 C₈H₁₇O—P(═O)—(OH)₂
RZ-2 C₁₂H₂₅O—P(═O)—(OK)₂
RZ-3 C₁₂H₂₅OCH₂CH₂O—P(═O)—(OK)₂
RZ-4 C₁₅H₃₁(OCH₂CH₂)₅O—P(═O)—(OK)₂
RZ-5 {C₁₂H₂₅O(CH₂CH₂O)₅}₂—P(═O)—OH
RZ-6 {C₁₈H₃₅(OCH₂CH₂)₈O}₂—P(═O)—ONH₄
RZ-7 (t-C₄H₉)₃—C₆H₂—OCH₂CH₂O—P(═O)—(OK)₂
RZ-8 (iso-C₉H₁₉—C₆H₄—O—(CH₂CH₂O)₅—P(═O)—(OK)(OH)
RZ-9 C₁₂H₂₅SO₃Na
RZ-10 C₁₂H₂₅OSO₃Na
RZ-11 C₁₇H₃₃COOH
RZ-12 C₁₇H₃₃COOH.N(CH₂CH₂OH)₃
RZ-13 iso-C₈H₁₇—C₆H₄—O—(CH₂CH₂O)₃—(CH₂)₂SO₃Na
RZ-14 (iso-C₉H₁₉)₂—C₆H₃—O—(CH₂CH₂O)₃—(CH₂)₄SO₃Na
RZ-15 sodium triisopropylnaphthalenesulfonate
RZ-16 sodium tri-t-butylnaphthalenesulfonate
RZ-17 C₁₇H₃₃CON(CH₃)CH₂CH₂SO₃Na
RZ-18 C₁₂H₂₅—C₆H₄SO₃.NH₄

The release agent is preferably added in an amount of 0.05% to 5%, more preferably 0.1% to 2%, even more preferably 0.1 to 0.5%, by weight based on the cyclic polyolefin.

The cyclic polyolefin film can contain a compound having at least two aromatic rings as a retardation developing agent to achieve a preferred retardation value. The retardation developing agent is preferably used in an amount of 0.05 to 20 parts by weight, more preferably 0.1 to 10 parts by weight, even more preferably 0.2 to 5 parts by weight, per 100 parts by weight of the polymer Two or more retardation developing agents may be used in combination.

It is preferred for the retardation developing agent to have the maximum absorption in a wavelength range of from 250 to 400 nm and not to have a substantial absorption in the visible region.

The terminology “aromatic ring” as used herein includes not only aromatic hydrocarbon rings but aromatic heterocyclic rings.

The aromatic hydrocarbon ring is preferably a 6-membered ring, namely a benzene ring.

The aromatic heterocyclic ring is generally an unsaturated heterocyclic ring. The aromatic heterocyclic ring is preferably a 5- to 7-membered ring, more preferably a 5- or 6-membered ring. The aromatic heterocyclic ring generally has a largest number of double bonds. The hetero atom of the aromatic heterocyclic ring preferably includes nitrogen, oxygen, and sulfur, with nitrogen being particularly preferred. Examples of the aromatic heterocyclic ring include a furan ring, a thiophene ring, a pyrrole ring, an oxazole ring, an isoxazole ring, a thiazole ring, an isothiazole ring, an imidazole ring, a pyrazole ring, a furazan ring, a triazole ring, a pyran ring, a pyridine ring, a pyridazine ring, a pyrimidine ring, a pyrazine ring, and a 1,3,5-triazine ring.

The aromatic ring preferably includes a benzene ring, a furan ring, a thiophene ring, a pyrrole ring, an oxazole ring, a thiazole ring, an imidazole ring, a triazole ring, a pyridine ring, a pyrimidine ring, a pyrazine ring, and a 1,3,5-triazine ring. A 1,3,5-triazine ring is particularly preferred. Specific examples of preferred retardation developing agents are given, e.g., in JP-A-2001-166144.

The number of the aromatic rings possessed by the retardation developing agent is preferably 2 to 20, more preferably 2 to 12, even more preferably 2 to 8, most preferably 2 to 6. The connection mode between two of the aromatic rings may be any of (a) fusion (to make a fused ring), (b) via a single bond, and (c) via a linking group. Being aromatic, the rings do not form a spiro bonding.

The fused rings (two or more aromatic rings fused together) include an indene ring, a naphthalene ring, an azulene ring, a fluorene ring, a phenanthrene ring, an anthracene ring, an acenaphthalene ring, a biphenylene ring, a naphthacene ring, a pyrene ring, an indole ring, an isoindole ring, a benzofuran ring, a benzothiophene ring, an indolizine ring, a benzoxazole ring, a benzothiazole ring, a benzimidazole ring, a benzotriazole ring, a purine ring, an indazole ring, a chromene ring, a quinoline ring, an isoquinoline ring, quinolidine ring, quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxathiin ring, a phenoxazine ring, and a thianthrene ring. Preferred of them are a naphthalene ring, an azulene ring, an indole ring, a benzoxazole ring, a benzothiazole ring, a benzimidazole ring, a benzotriazole ring, and a quinoline ring.

The single bond in the connection mode (b) is preferably a bond between carbon atoms of the two aromatic rings. Two aromatic rings may be connected via two or more single bonds to form an aliphatic ring or a non-aromatic heterocyclic ring therebetween.

The linking group in the connection mode (c) is preferably between carbon atoms of the two aromatic rings. The linking group preferably includes an alkylene group, an alkenylene group, an alkynylene group, —CO—, —O—, —NH—, —S—, and combinations thereof. Examples of the combination of linking groups are shown below. The order of the unit linking groups may be inverted.
c1: —CO—O—
c2: —CO—NH—
c3: -alkylene-O—
c4: —NH—CO—NH—
c5: —NH—CO—O—
c6: —O—CO—O—
c7: —O-alkylene-O—
C8: —CO-alkenylene-
C9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic rings and the linking groups may have a substituent. The substituent includes a halogen atom (e.g., F, Cl, Br or I), a hydroxyl group, a carboxyl group, a cyano group, an amino group, a nitro group, a sulfo group, a carbamoyl group, a sulfamoyl group, a ureido group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amido group, an aliphatic sulfonamido group, an aliphatic substituted amino group, an aliphatic substituted carbamoyl group, an aliphatic substituted sulfamoyl group, an aliphatic substituted ureido group, and a non-aromatic heterocyclic group.

The alkyl group preferably contains 1 to 8 carbon atoms. An acyclic alkyl group is preferred to a cyclic alkyl group, and a straight-chain alkyl group is preferred to a branched one. The alkyl group may have a substituent (e.g., hydroxyl, carboxyl, alkoxy or alkylamino). Examples of the substituted or unsubstituted alkyl group are methyl, ethyl, n-butyl, n-hexyl, 2-hydroxyethyl, 4-carboxybutyl, 2-methoxyethyl, and 2-diethylaminoethyl.

The alkenyl group preferably contains 2 to 8 carbon atoms. An acyclic alkenyl group is preferred to a cyclic alkenyl group, and a straight-chain alkenyl group is preferred to a branched one. The alkenyl group may have a substituent. Examples of the alkenyl group are vinyl, allyl, and 1-hexenyl.

The alkynyl group preferably contains 2 to 8 carbon atoms. An acyclic alkynyl group is preferred to a cyclic one. A straight-chain alkynyl group is preferred to a branched one. The alkynyl group may have a substituent. Examples of the alkynyl group are ethynyl, 1-butynyl, and 1-hexynyl.

The aliphatic acyl group preferably has 1 to 10 carbon atoms. Examples of the aliphatic acyl group include acetyl, propanoyl, and butanoyl.

The aliphatic acyloxy group preferably contains 1 to 10 carbon atoms. Examples of the aliphatic acyloxy group include acetoxy.

The alkoxy group preferably contains 1 to 8 carbon atoms. The alkoxy group may have a substituent (e.g., an alkoxy group). Examples of the substituted or unsubstituted alkoxy group include methoxy, ethoxy, butoxy, and methoxyethoxy.

The alkoxycarbonyl group preferably contains 2 to 10 carbon atoms. Examples of the alkoxycarbonyl group include methoxycarbonyl and ethoxycarbonyl.

The alkoxycarbonylamino group preferably contains 2 to 10 carbon atoms. Examples of the alkoxycarbonylamino group include methoxycarbonylamino and ethoxycarbonylamino.

The alkylthio group preferably contains 1 to 12 carbon atoms. Examples of the alkylthio group are methylthio, ethylthio, and octylthio.

The alkylsulfonyl group preferably contains 1 to 8 carbon atoms. Examples of the alkylsulfonyl group are methanesulfonyl and ethanesulfonyl.

The aliphatic amido group preferably contains 1 to 10 carbon atoms. Examples include acetamido.

The aliphatic sulfonamido group preferably contains 1 to 8 carbon atoms. Examples include methanesulfonamido, butanesulfonamido, and n-octanesulfonamido.

The aliphatic substituted amino group preferably contains 1 to 10 carbon atoms. Examples of the aliphatic substituted amino group include dimethylamino, diethylamino, and 2-carboxyethylamino.

The aliphatic substituted carbamoyl group preferably contains 2 to 10 carbon atoms. Examples are methylcarbamoyl and diethylcarbamoyl.

The aliphatic substituted sulfamoyl group preferably contains 1 to 8 carbon atoms. Examples include methylsulfamoyl and diethylsulfamoyl.

The aliphatic substituted ureido group preferably contains 2 to 10 carbon atoms. Examples include methylureido.

The non-aromatic heterocyclic group includes piperidino and morpholino.

The retardation developing agent preferably has a molecular weight of 300 to 800.

In addition to the compounds having a 1,3,5-triazine ring, rod-like compounds having a straight-linear molecular structure and containing at least two aromatic rings are also preferred as a retardation developing agent. To have a “straight-linear molecular structure” means that the compound has a straight-linear molecular structure when it is in its most thermodynamically stable state. The most thermodynamically stable structure can be obtained through crystal structure analysis or molecular orbital calculation. For instance, molecular orbital calculation is performed with molecular orbital calculation software (e.g., WinMOPAC 2000 form Fujitsu Ltd.) to obtain the molecular structure in which the heat of formation is lowest. To have a “straight-linear molecular structure” indicates that the molecular main chain makes an angle of 140° or larger in the thermodynamically most stable structure as determined.

The rod-like compounds having at least two aromatic rings preferably include those represented by formula (VI):

Ar¹-L¹-Ar² (VI)

wherein Ar¹ and Ar² each represent an aromatic group, and L¹ is a divalent linking group.

In formula (VI), the terminology “aromatic group” includes an aryl group (aromatic hydrocarbon group), a substituted aryl group, an aromatic heterocyclic group, and a substituted aromatic heterocyclic group. A substituted or unsubstituted aryl group is preferred to a substituted or unsubstituted aromatic heterocyclic group. The aromatic heterocyclic ring is generally unsaturated. The aromatic heterocyclic ring is preferably a 5- to 7-membered ring, more preferably a 5- or 6-membered ring. The aromatic heterocyclic ring generally has a largest number of double bonds. The hetero atom possessed by the aromatic heterocyclic ring preferably includes nitrogen, oxygen and sulfur atoms. A nitrogen atom or a sulfur atom is still preferred.

The aromatic ring of the aromatic group includes a benzene ring, a furan ring, a thiophene ring, a pyrrole ring, an oxazole ring, a thiazole ring, an imidazole ring, a triazole ring, a pyridine ring, a pyrimidine ring, and a pyrazine ring, with a benzene ring being particularly preferred.

The divalent linking group represented by L¹ is selected from an alkylene group, an alkenylene group, an alkynylene group, —O—, —CO—, and combinations thereof.

The alkylene group may have a cyclic structure A cyclic alkylene group is preferably a cyclohexylene group, particularly preferably a 1,4-cyclohexylene group. A straight-chain acyclic alkylene group is preferred to a branched acyclic alkylene group. The alkylene group preferably contains 1 to 20 carbon atoms, more preferably 1 to 15 carbon atoms, even more preferably 1 to 10 carbon atoms, particularly preferably 1 to 8 carbon atoms, especially preferably 1 to 6 carbon atoms.

The alkenylene group and the alkynylene group preferably have an acyclic structure A straight-chain acyclic structure is preferred to a branched one. The alkenylene group and the alkynylene group preferably contain 2 to 10 carbon atoms, more preferably 2 to 8 carbon atoms, even more preferably 2 to 6 carbon atoms, particularly preferably 2 to 4 carbon atoms, most preferably 2 carbon atoms (i.e., vinylene or ethynylene).

The arylene group preferably contains 6 to 20 carbon atoms, more preferably 6 to 16 carbon atoms, even more preferably 6 to 12 carbon atoms.

In the molecular structure of formula (VI), Ar¹ and Ar² preferably make an angle of 140° or greater at L¹.

Of the rod-like compounds of formula (VI) preferred are those represented by formula (VII):

Ar¹-L²-X-L₃-Ar² (VII)

wherein Ar¹ and Ar² are as defined above, L² and L³ each represent a divalent linking group selected from an alkylene group, —O—, —CO— or a combination thereof; and X represents 1,4-cyclohexylene, vinylene or ethynylene.

The alkylene group as L² or L³ preferably has an acyclic structure rather than a cyclic structure. The acyclic alkylene group preferably has a straight-linear structure rather than a branched structure. The alkylene group preferably contains 1 to 10 carbon atoms, more preferably 1 to 8 carbon atoms, even more preferably 1 to 6 carbon atoms, particularly preferably 1 to 4 carbon atoms, and especially 1 or 2 carbon atoms (i.e., methylene or ethylene).

L² and L³ each preferably represent —O—CO— or —CO—O—.

Two or more kinds of the rod-like compounds showing, in their solutions, the absorption peaks (λmax) at 250 nm or shorter wavelengths in the UV absorption spectrum may be used in combination.

The retardation developing agent is preferably added in an amount of 0.1% to 30% by weight, more preferably 0.5% to 20% by weight, based on the cyclic polyolefin.

The process of forming the cyclic olefin resin film of the invention includes solvent casting and melt film formation. Solvent casting that provides a film with good surface properties is preferred. Solvent casting will be described first with reference to its preferred embodiment.

A solvent casting process for forming the cyclic polyolefin film of the invention preferably includes the steps of casting a dope containing a cyclic olefin resin and fine particles on a support, peeling the cast film from the support, and drying the cast film.

Preferably, the process further includes the step of stretching the cast film peeled off the support.

The organic solvents that can be used to dissolve the cyclic polyolefin to prepare a film-forming solution (dope) will be described. The organic solvents to be used are not limited as long as the object is accomplished. Exemplary organic solvents to be used include chlorine-containing solvents, such as dichloromethane and chloroform, acyclic, cyclic or aromatic hydrocarbons having 3 to 12 carbon atoms, esters having 3 to 12 carbon atoms, ketones having 3 to 12 carbon atoms, and ethers having 3 to 12 carbon atoms. The esters, ketones and ethers may have a cyclic structure. The acyclic hydrocarbons having 3 to 12 carbon atoms include hexane, octane, isooctane, and decane. The cyclic hydrocarbons having 3 to 12 carbon atoms include cyclopentane, cyclohexane, decaline, and derivatives thereof. The aromatic hydrocarbons having 3 to 12 carbon atoms include benzene, toluene, and xylene. The esters having 3 to 12 carbon atoms include ethyl formate, propyl formate, pentyl formate, methyl acetate, ethyl acetate, and pentyl acetate. The ketones having 3 to 12 carbon atoms include acetone, methyl ethyl ketone, diethyl ketone, diisobutyl ketone, cyclopentanone, cyclohexanone, and methylcyclohexanone. The ethers having 3 to 12 carbon atoms include diisopropyl ether, dimethoxymethane, dimethyloxyethane, 1,4-dioxane, 1,3-dioxolane, tetrahydrofuran, anisole, and phenetole. Organic solvents having two or more kinds of functional groups are also preferred, including 2-ethoxyethyl acetate, 2-methoxyethanol, and 2-butoxyethanol. The organic solvent preferably has a boiling point of 35° to 200° C. Two or more kinds of the solvents can be used to control the drying properties of the dope and the solution properties such as viscosity. It is also possible to add a poor solvent as long as the mixed solvent system is capable of dissolving the cyclic polyolefin.

The poor solvent to be used is selected as appropriate to the kind of the polymer. Where a chlorine-containing organic solvent is used as a good solvent, an alcohol is a preferred poor solvent. The alcohol may be straight, branched or cyclic. A saturated aliphatic hydrocarbon is preferred. The hydroxyl group of the alcohol may be primary, secondary or tertiary. A fluoroalcohol such as 2-fluoroethanol, 2,2,2-trifluoroethanol, or 2,2,3,3-tetrafluoro-1-propanol is also useful. Of these alcohols, monohydric ones are preferably used for their effect in reducing resistance to peeling. While a choice of an alcohol as a poor solvent depends on the good solvent selected, preferred for the consideration of drying load are those having a boiling point of 120° C. or lower, more preferred are monohydric ones having 1 to 6 carbon atoms, even more preferred are those having 1 to 4 carbon atoms. A particularly preferred solvent system for preparing a cyclic polyolefin solution comprises dichloromethane as a main solvent and at least one poor solvent selected from methanol, ethanol, propanol, isopropyl alcohol, and butanol.

The cyclic polyolefin solution (dope) can be prepared by, for example, a room-temperature dissolving method in which the system is stirred at room temperature, a cooling dissolving method in which the system is stirred at room temperature to swell the polymer, cooled to −20° to −100° C., and heated to 20° to 100° C. to dissolve the polymer, a high-temperature dissolving method in which the system is heated in a closed container to a temperature at or above the boiling point of the main solvent to dissolve the polymer, or a method in which the temperature and pressure are raised up to the critical point of the solvent to dissolve the polymer. A dope of a soluble polymer is preferably prepared by the room-temperature dissolving method. A dope of a hardly soluble polymer is preferably prepared by the method by heating in a closed container. Unless the polymer has poor solubility, to choose a dissolving temperature as low as possible gives a process convenience.

The cyclic polyolefin solution preferably has a viscosity of 1 to 500 Pa·s, more preferably 5 to 200 Pa·s, at 25° C. The viscosity measurement is made on 1 ml of a sample solution with a rheometer CSL 500 (from TA Instruments Inc.) using a stainless steel cone and plate geometry (cone diameter of 4 cm and angle of 2°) (from TA Instruments). The measurement is taken after maintaining a sample solution at the measuring temperature (25° C.) until the sample temperature becomes stationary.

With the solvent to be used being properly chosen, the cyclic polyolefin allows for preparation of a high-concentration and yet highly stable dope without requiring the operation of concentration. Understandably, the operation of concentration may be used where a polymer solution at a lower concentration is once prepared and then concentrated to a desired concentration to make the operation of dissolving easier. Concentration can be carried out by any method. For example, the method of JP-A-4-259511 is useful, in which a low concentration solution is introduced into a cylinder between the inner wall of the cylinder and the periphery of a rotating blade rotating along the inner wall of the cylinder while affording a temperature difference to the solution thereby causing the solvent to evaporate. The method disclosed in U.S. Pat. Nos. 2,541,012, 2,858,229, 4,414,341, and 4,504,355 is also practical, in which a heated low-concentration solution is sprayed into a container from a nozzle, and the solvent is flash-evaporated before the solution strikes against the inner wall of the container. The solvent vapor is driven out of the container, and the concentrated solution is withdrawn from the bottom of the container.

The dope is preferably filtered through an appropriate filter media such as a metal wire cloth or flannel to remove insoluble matter and foreign matter (e.g., dust and impurity). To filter the cyclic polyolefin dope it is preferred to use a filter with an absolute filtration rating of 0.1 to 100 μm, more preferably 0.5 to 25 μm. The filter thickness is preferably 0.1 to 10 mm, more preferably 0.2 to 2 mm. With that thickness, the filtration pressure is preferably 1.6 MPa or lower, more preferably 1.3 MPa or lower, even more preferably 1.0 MPa or lower, particularly preferably 0.6 MPa or lower. Filter medias of known materials including glass fiber, cellulose fiber, filter paper, and fluoropolymers such as polytetrafluoroethylene are used. Filter medias made of ceramics or metals are also suitable.

The viscosity of the dope immediately before casting should be within a range suitable for casting, which is preferably from 5 to 1000 Pa·s, more preferably 15 to 500 Pa·s, even more preferably 30 to 200 Pa·s. The temperature of the dope immediately before casting should be within a range of the temperature at the casting, which is preferably −5° to 70° C., more preferably −5° to 35° C.

Solvent casting using the cyclic polyolefin dope is preferably carried out using a method and equipment conventionally employed in the formation of a cellulose triacetate film. The following is a preferred embodiment of cyclic polyolefin film formation by solvent casting, which is not limiting the invention.

A cyclic polyolefin dope prepared in a dissolving vessel is once stored in a storage tank for defoaming. The thus obtained final dope is fed to a pressure die through a pressure pump, e.g., a constant displacement gear pump capable of precise metering by the number of rotations and uniformly cast through the slot of the pressure die on an endlessly moving metal support. When the dope on the support makes almost one revolution and reaches a peeling position, by which time the dope has half-dried, the half-dried dope called a web is peeled off the support. The web is dried while being conveyed by a tenter with its width fixed by clips, finally dried while moving on a group of rolls in a dryer, and taken up on a winder with a prescribed length. The combination of the tenter and the dryer having rolls is subject to alteration depending on the purpose. Where a functional protective film for application to electronic displays is produced, the solvent casting equipment is often combined with coaters to provide a functional layer, such as an undercoating layer, an antistatic layer, an anti-halation layer, or a protective layer, on the cast film.

Each of the steps involved in the formation of the cyclic polyolefin film will be briefly illustrated below, but the invention is not restricted thereto.

The finally prepared dope is preferably cast on an endless metallic support, e.g., a drum or a belt, and the solvent is made to evaporate to form a film. The dope to be cast is preferably adjusted to have a solids content of 10% to 35% by weight. The surface of the support is preferably mirror finished. The support surface temperature is preferably 30° C. or lower, more preferably −10° to 20° C. The film forming techniques taught in JP-A-2000-301555, JP-A-2000-301558, JP-A-7-32391, JP-A-3-193316, JP-A-5-86212, JP-A-62-37113, JP-A-2-276607, JP-A-55-14201, JP-A-2-111511, and JP-A-2-208650 can be made use of.

Solvent casting may be carried out using a single cyclic polyolefin dope, or two or more dopes may be cast on the same support (layered casting) to obtain a multilayered cast film. Layered casting can be carried out by casting the dopes through the respective dies provided at spacing in the moving direction of the support. The techniques described in JP-A-61-158414, JP-A-1-122419, and JP-A-11-198285 can be utilized. Layered casting may also be performed by co-casting two dopes through the respective die slots as described, e.g., in JP-B-60-27562, JP-A-61-94724, JP-A-61-947245, JP-A-61-104813, JP-A-61-158413, and JP-A-6-134933. The solvent casting technique proposed in JP-A-56-162617 is also useful, in which a flow of a high viscosity dope is surrounded by a flow of a low viscosity dope, and the two dopes are simultaneously extruded onto a support. In a preferred embodiment, the content of an alcohol component as a poor solvent is made higher in the outer dope than in the inner dope as proposed in JP-A-61-94724 and JP-A-61-94725. The technique disclosed in JP-B-44-20235 is also useful, in which a cast film formed by casting a first dope on a support from a first die is peeled, and a second dope is cast from a second die onto the cast film on the side that has been in contact with the support. The two or more cyclic polyolefin dopes used in layered casting may be either the same or different. To impart functions to two or more cyclic polyolefin cast layers, cyclic polyolefin dopes appropriate for the respective functions may be extruded from the respective slots. It is also possible to cast the cyclic polyolefin dope simultaneously with other functional layers (for example, an adhesive layer, a dye layer, an antistatic layer, an anti-halation layer, a UV absorbing layer and a polarizing layer).

To achieve a required film thickness by single layer casting, it is necessary to extrude a high-concentration, high-viscosity cyclic polyolefin dope. Such a dope has poor stability and tends to form solid matter, which can often cause machine trouble, or result in formation of a cast film with poor surface smoothness. The above-described layered casting provides a solution to this problem. Since a plurality of highly viscous dopes are cast from the respective die slots on a metal support simultaneously, the resulting cast film exhibits excellent surface properties such as improved smoothness. Furthermore, use of thick dopes contributes to decrease in drying load and increase of production speed. In the case of co-casting, the thickness of the inner layer and that of the outer layer are not particularly limited. It is preferable that the outer thickness is 1% to 50%, more preferably 2% to 30%, of the total thickness. In the case of co-casting three or more layers, the total film thickness of the layer having been in contact with the metal support and the layer having been in contact with the atmosphere is defined as “outer thickness”. Cyclic polyolefin dopes differing from each other in concentrations of the above-described additives such as a deterioration inhibitor, a UV absorber, and a matting agent can be co-cast to form a cyclic polyolefin film having a multilayered structure (laminate film). For example, a cyclic polyolefin laminate film composed of a skin layer/a core layer/a skin layer can be obtained. In this layer structure, a matting agent, for example, may be added in a larger amount to the skin layers or exclusively added to the skin layers. A deterioration inhibitor and a UV absorber may be added in larger amounts to the core layer than to the skin layer or added only to the core layer. The kind of deterioration inhibitors or UV absorbers may be changed between the core layer and the skin layers. For example, a less volatile deterioration inhibitor and/or UV absorber may be added to the skin layers, while a plasticizer having an excellent plasticizing effect or a UV absorber showing high UV absorption may be added to the core layer. It is also a preferred embodiment to add a release agent only to the support side skin layer. In case of chill-roll extrusion, since the dope is gelled by cooling the metal support, it is preferred to add an alcohol, i.e., a poor solvent in a larger amount to the skin layer. The skin layers and the core layer may have different Tgs. It is preferred that the Tg of the core layer be lower than that of the skin layer. The dopes for the skin layer and the core layer may have different viscosities. While it is usually preferred that the viscosity of the skin layer be lower than that of the core layer, the viscosity of the core layer may be lower than that of the skin layer.

Casting a dope is carried out by, for example, a method wherein a prepared dope is uniformly extruded from a pressure die onto a metal support, a method in which a dope once cast on a metal support is leveled with a doctor blade to control the film thickness or a method using a reverse roll coater in which the film thickness is controlled by a roll rotating in the reverse direction. The method using a pressure die is preferred. Pressure dies include a coathanger type and a T-die type, each of which can be used preferably. In addition to the methods described above, use can be made of various solvent casting techniques known for forming a cellulose acylate film. By properly selecting conditions taking the differences, e.g., in boiling point of solvents into consideration, the effects and advantages as reported in the publications will be obtained.

The continuously moving metal support to be used in solvent casting includes a drum having the surface mirror finished by chromeplating and a stainless steel belt or band having the surface mirror polished. One or more pressure dies are provided above the metal support. A preferred number of the pressure dies is one or two. Where two or more pressure dies are provided, the dope to be cast may be divided into portions in amounts appropriate for the respective dies. It is also possible to feed the dope in predetermined amounts into the dies by using respective precise metering gear pumps. The temperature of the cyclic polyolefin dope to be cast preferably ranges from −5° to 70° C., more preferably from −5° to 35° C. The dope temperature may be maintained constant throughout the process involved in the dope preparation or vary from stage to stage. In the latter case, the temperature should be at a prescribed level immediately before being cast.

The cyclic polyolefin web on the metal support is dried usually by blowing hot air to the metal support (a drum or a belt), i.e., the exposed side of the web on the metal support or to the inner side of the drum or belt, or applying a temperature-controlled liquid to the inner side of the drum or belt (i.e., the side opposite to the casting side) to heat the drum or the belt by heat transfer and control the surface temperature. The liquid heat transfer method is preferred. The surface temperature of the metal support before casting is not limited as long as it is below the boiling points of the solvents used in the dope. To promote the drying or the loss of fluidity of the web on the metal support, it is preferred to set the support surface temperature lower than the lowest boiling point of the solvents used in the dope by 1° to 10° C. This does not apply, however, to the case where the web is peeled after cooling without drying.

Where a half-dried web has high peel resistance (requires high peeling load) when peeled off the metal support, irregularly stretching can occur in the machine direction to develop optical unevenness (anisotropy). With an appreciable peel resistance, the film can discontinuously undergo stretching in the machine direction, resulting in alternation of stretched parts and unstretched parts along the machine direction, which causes a distribution of retardation. When an optical film with such a distribution of retardation is applied to LCDs, streaky or banded unevenness would appear. To avert this problem, it is preferred to limit the peeling load of the film to 0.25 N or less per cm of the peel width. The peeling load is more preferably 0.2 N/cm or less, even more preferably 0.15 N/cm or less, particularly preferably 0.10 N/cm or less. When the peeling load of a film is 0.2 N/cm or less, unevenness attributed to peeling will not at all appear even when the film is applied to an LCD on which unevenness is easily visualized. Reduction of peeling load can be accomplished by addition of a release agent as previously stated or by proper selection of the solvent system.

A peeling load is measured as follows A dope is dropped on a metal plate made of the same material and having the same surface roughness as the metal support of a film forming apparatus. The dope is spread to a uniform thickness with a doctor blade and dried. The film as formed on the plate is cut into strips of the same width with a retractable knife. One end of each strip is peeled off the plate with fingers and held by a clip connected to a strain gauge. The strip is peeled at 45° by obliquely lifting the strain gauge to record the change in load. The residual volatile content of the peeled strip of the film is measured. The same measurements are repeated several times while varying the drying time. The peeling load required to peel the strip having the same residual volatile content as in an actual peeling step is obtained. Because the peeling load tends to increase with an increase of peeling speed, the measurement is preferably conducted at a peeling speed close to an actual speed.

A preferred residual volatile content at the peeling is preferably 5% to 60% by weight, more preferably 10% to 50% by weight, even more preferably 20% to 40% by weight. Peeling a cast film while a high volatile content remains allows raising the speed of drying, which means improvement of productivity. A film with too high a residual volatile content, however, has too small strength and elasticity to withstand the peeling force and easily cuts or stretches when peeled. Besides, a film with too high a residual volatile content has poor self-supporting properties after being peeled and easily undergoes film defects, such as deformation, wrinkles, and knicks, and creates a distribution of retardation.

Where the process includes the step of stretching the resulting cyclic polyolefin film, stretching is preferably carried out shortly after the peeling, in other words, while a sufficient amount of the solvent remains in the film. The purpose of stretching is (1) to provide a film with excellent flatness free from wrinkles or deformation and/or (2) to enhance the in-plane retardation of the film. For the purpose (1), the stretching is preferably performed at a relatively high temperature at a stretch ratio of from 1% to 10% at the most, more preferably 2% to 5%. For the purpose (2) or for the purposes (1) and (2), the stretching is preferably carried out at a relatively low temperature at a stretch ratio of 5% to 150%.

The stretching is either uniaxial (MD or TD) or biaxial (either simultaneous or successive). A retardation film (birefringent optical film) applied to a VA mode liquid crystal cell or an OCB mode liquid crystal cell preferably has a larger refractive index in the width direction than in the length direction. Accordingly, it is recommended to stretch the film at a higher ratio in the width direction than in the length direction.

It is preferred that the stretched cyclic polyolefin film be subjected to post-drying to reduce the residual volatile content to 2% or lower before being wound into roll.

The thickness of the cyclic polyolefin film (after drying) varies depending on the intended use. It usually ranges from 20 to 500 μm, preferably 30 to 150 μm. For use in LCDs, it is preferably 40 to 110 μm.

A desired film thickness can be obtained by adjusting the solids concentration of the dope, the slot gap of the die, the extrusion pressure from the die, the moving speed of the metal support, and the like.

The width of the cyclic polyolefin film thus obtained is preferably 0.5 to 3 m, more preferably 0.6 to 2.5 m, even more preferably 0.8 to 2.2 m. The length of the film wound per roll is preferably 100 to 10,000 m, more preferably from 500 to 7,000 m, even more preferably 1,000 to 6,000 m. Before being wound up, the film is preferably knurled along at least one margin thereof from one or both sides thereof. The knurling width is preferably 3 to 50 mm, more preferably 5 to 30 mm, and the knurling height is preferably 0.5 to 500 μm, more preferably from 1 to 200 μm.

Variation in Re in the width direction is preferably within ±5 nm, more preferably ±3 nm Variation in Rth in the width direction is preferably ±10 nm, more preferably ±5 nm. The same preference applies to variations in Re and Rth in the longitudinal direction. To secure transparency, the haze of the film is preferably 0.01% to 2%.

Melt film formation, another process of forming the cyclic polyolefin film of the invention, will then be described with reference to its preferred embodiment A melt film formation process for forming the cyclic polyolefin film of the invention usually includes the steps of extruding a molten cyclic olefin resin (melt) from an extruder die into sheeting and cooling the extruded film on a chill roll to form a base film.

The cyclic olefin resin pellets can be preheated before being melted. The preheating temperature preferably ranges from (Tg−90)° C. to (Tg+15)° C. Preheating at that temperature facilitates uniform melt-kneading and obtaining desired Hv scattering intensity and Vv scattering intensity. The preheating temperature is more preferably (Tg−75)° C. to (Tg−5)° C., even more preferably (Tg−70)° C. to (Tg−5)° C.

The preheated resin is melted in an extruder preferably at a temperature of 200° to 300° C. The outlet temperature of the extruder is preferably set higher than the inlet temperature by 5° to 100° C., more preferably 20° to 90° C., even more preferably 30° to 80° C. To set the outlet temperature higher than the inlet temperature facilitates uniform melt-kneading and obtaining desired Hv and Vv scattering intensities.

The melt is passed through a gear pump to eliminate pulsation, filtered through, e.g., a wire cloth filter, and extruded through a T-die onto a chill roll. The extruded film web is pressed against the chill roll. Pressing is preferably done over a width of 1% to 50%, more preferably 2% to 40%, even more preferably 3% to 30%, of the film width. More preferably, the film is pressed uniformly in side portions along both edges totally corresponding to 1% to 50% of the film width.

There is a possibility that the film suffers from unevenness of cooling due to unevenness of the pressing force or unevenness of the chill roll temperature in the width direction, resulting in nonuniformity of shrinkage stress in the width direction. If the extruded film is pressed against the chill roll over its whole width, such a nonuniform shrinkage stress is not allowed to escape from the film because the film is pressed against the chill roll over its whole width. Furthermore, when pressed against the chill roll over its whole width, the extruded film drastically falls in temperature, which can result in unevenness of Re and Rth, particularly Rth. The above-described manner of pressing provides a solution to these problems. That is, nonuniform shrinkage stress in the extruded film is avoided, and development of Re and Rth unevenness can be suppressed.

The method of pressing the extruded film against the chill roll is not particularly limited. For example, pressing can effectively be achieved by means of an air chamber, a vacuum nozzle or a touch roll or by electrostatic pinning. The pressing pressure is not limited but preferably ranges from 0.001 to 20 kg/cm² (98 Pa to 1.96 MPa), more preferably 0.01 to 1 kg/cm² (980 Pa to 98 kPa).

The pressing can be effected while cooling the film on the chill roll. The cooling is preferably carried out as slowly as possible. While a cooling rate generally practiced in melt film formation is 50° C./sec or higher, the cooling rate suitable in the present embodiment is 0.2° to 20° C./min, preferably 0.5° to 15° C./sec, more preferably 1° to 10° C./sec. In that range of cooling rate, occurrence of local unevenness of cooling is prevented, generation of shrinkage stress due to abrupt shrinkage is prevented, and development of Re and Rth unevenness is suppressed.

The slow cooling is preferably achieved by controlling the temperature in the casing of the chill roll or controlling the temperature of the chill roll per se. The former means produces better results.

When the former means is adopted, at least one of chill rolls is placed in a casing the inner temperature of which is controlled preferably in the range of from (Tg−100)° C. to (Tg+30)° C., more preferably (Tg−80)° C. to (Tg+10)° C., even more preferably (Tg−70)° C. to Tg. A film extruded onto a chill roll is liable to suffer from Re and Rth unevenness because it is restrained by the friction against the chill roll and not allowed to shrink freely. The slow cooling method described above allows for uniform slow cooling in the width direction with minimum unevenness in film temperature on the chill roll. As a result, Re and Rth unevenness can be reduced.

JP-A-2003-131006 discloses a film forming process in which the film temperature in the air gap between a T-die and a cooling drum is controlled. This technique can be utilized in the present invention.

The following film cooling methods can be used for minimizing Re and Rth unevenness.

(1) The melt web extruded from the die extruder is cast on closely and regularly spaced two to ten, preferably two to six, more preferably three or four, chill rolls. By using a plurality of chill rolls to control the cooling temperature, it is easy to control the cooling rate. By regularly spacing the chill rolls, change in temperature between the chill rolls can be minimized. The distance between the chill rolls (the minimum distance between the outer peripheries of adjacent chill rolls) is preferably 0.1 to 15 cm, more preferably 0.3 to 10 cm, even more preferably 0.5 to 5 cm.
(2) At least the first one out of the two to ten chill rolls is preferably set at (Tg−40)° C. to Tg (Tg. of the cyclic olefin resin), more preferably (Tg−35)° C. to (Tg−3)° C., even more preferably (Tg−30)° C. to (Tg−3)° C., most preferably (Tg−30)° C. to (Tg−5)° C. The second chill roll is preferably set at a temperature higher than that of the first one by 10 to 30° C., more preferably 1° to 20° C., even more preferably 1° to 10° C. By setting the temperature of the second chill roll higher than that of the first one, the cyclic olefin resin film gains in viscosity to exhibit enhanced adhesion to the second chill roll. Thus, the film is prevented from slipping on the chill rolls and undergoing variation of conveying tension. As a result, Re and Rth unevenness is reduced.
(3) The take-up speed of the second chill roll is preferably set higher than that of the first one by 0.1% to 5%, more preferably 0.2% to 4%, even more preferably 0.3% to 3%, whereby the film is prevented from slipping and undergoing variation of conveying tension between the first and the second chill rolls. As a result, Re and Rth unevenness is reduced.
(4) The film from the second chill roll is preferably passed over the third one set at a temperature lower than that of the second one by 10 to 30° C., more preferably 1.5° to 20° C., even more preferably 2° to 10° C., whereby the cooling rate in the step of peeling the cyclic olefin resin film from the chill roll can be reduced. As a result, Re and Rth unevenness is reduced. It is further preferred that the take-up speed of the third chill roll be lower than that of the second one by 0.1% to 5%, more preferably 0.2% to 4%, even more preferably 0.3% to 3%, whereby the tension unevenness between the second and the third chill rolls is reduced. As a result, Re and Rth unevenness is reduced.

After the cyclic olefin resin film is cooled preferably at a cooling rate of 0.2° to 20° C./sec as described above, the film is peeled from the chill roll.

The peeled film can be conveyed by a plurality of carrying rolls preferably arranged at a distance of 0.2 to 10 m, more preferably 0.3 to 8 m, even more preferably 0.4 to 6 m. With such a long span between carrying rolls on which the film runs while being cooled, the unevenness in conveying tension attributed to the friction against the carrying rolls can be alleviated. In order to correct the unbalance of conveying tension accompanying the cooling shrinkage nonuniformity across the film width, a sufficient roll-to-roll distance is required for allowing the film to move freely thereby. Within the above-recited roll-to-roll distance range, the cyclic olefin resin film is allowed to move freely without generating friction against the carrying rolls, thereby to reduce the deviation of the optical axis caused by the tension unevenness.

The film peeled off the chill roll is preferably cooled to 50° C. The cooling rate is preferably 0.1°/sec to 3° C./sec, more preferably 0.2° C./sec to 2.5° C./sec, even more preferably 0.3° C./sec to 2° C./sec. Cooling at a rate of 0.1° to 3° C./sec prevents deviation of the optical axis due to tension unevenness across the width caused by abrupt shrinkage stress. The cooling rate can be so controlled by passing the film in a casing of the carrying rolls in which air is blown at a temperature lower in the downstream than in the upstream or by varying the temperature of the carrying rolls between the upstream and the downstream.

In the present embodiment, the rate of film formation is preferably 40 to 150 m/min, more preferably 50 to 100 m/min, even more preferably 60 to 80 m/min. At the preferred film forming rate, air is entrapped between the extruded melt film and the first chill roll to prevent the film from being pressed against the whole surface of the chill roll. As a result, Re and Rth unevenness can be reduced.

The width of the film is preferably 0.5 to 3 m, more preferably 1.5 to 2.8 m, even more preferably 1.7 to 2.5 m. Unevenness of shrinkage stress can occur across the film width while the film peeled off the chill roll runs on carrying rolls. Such shrinkage stress unevenness can be minimized by making the film with such a large width. In other words, a wide film is capable of absorbing and leveling the generated tension unevenness in its width direction thereby to reduce optical axis unevenness, which is not the case with a narrow film.

A polarizing plate usually has a polarizer and a protective film on both sides of the polarizer. The cyclic polyolefin film of the invention is useful as at least one of the protective films. The other protective film may be a commonly used cellulose acetate film.

In protective film application, the cyclic olefin resin film of the invention can be used as a protective film on both sides or one side of a polarizer. In the latter application, the protective film on the opposite side can be of a conventional film such as a cellulose triacetate film. Since the cyclic olefin resin film of the invention has a close moisture permeability to a cellulose triacetate film, a polarizing plate having the cyclic olefin resin film on one side and the cellulose triacetate film on the other side suffers from no or little manufacturing and fabrication problems such as curling.

At least one of the two protective films of the polarizing plate may be a retardation film. A retardation film is capable of improving viewing angle characteristics of an LCD. Preferred optical characteristics of the cyclic polyolefin film for use as a polarizer protective film combined with a function as a retardation film will be described later with reference to a retardation film.

The cyclic polyolefin film for use as a polarizer protective film preferably has an in-plane retardation (Re) of 5 nm or smaller, more preferably 3 nm or smaller, and a thickness direction retardation (Rth) of 50 nm or smaller, more preferably 35 nm or smaller, even more preferably 10 nm or smaller.

Polarizers include an iodine polarizer, a dichroic polarizer, and a polyene polarizer. The iodine polarizer and the dichroic polarizer are generally prepared using PVA film.

For application as a polarizer protective film, the cyclic polyolefin film is subjected to a surface treatment described below and adhered on its surface-treated side to a polarizer via an adhesive. Useful adhesives include PVA adhesives such as PVA and polyvinyl butyral, vinyl lattices such as butyl acrylate, and gelatin. The polarizing plate composed of the polarizer and protective films on both sides thereof can further has a releasable protective sheet on one side thereof and a separate sheet on the other side. Both the releasable protective sheet and the separate sheet provide the polarizing plate with a protection during shipment or inspection of the polarizing plate. The protective sheet is for protecting the viewer's side of the polarizing plate, while the separate sheet is for covering the adhesive layer with which the polarizing plate is bonded to the liquid crystal cell.

The cyclic polyolefin protective film is preferably bonded to the polarizer with its slow axis coinciding with the transmission axis of the polarizer. Evaluation of a polarizing plate constructed under crossed Nicols revealed that, if a deviation from perpendicularity between the slow axis of the cyclic polyolefin film and the absorption axis of the polarizer (orthogonal to the transmission axis of the polarizer) exceeds 1°, the polarizing performance under crossed Nicols reduces to cause light leakage. When combined with a liquid crystal cell, such a polarizing plate would fail to provide a sufficient black level or contrast. It is therefore desirable that the deviation of the direction of the main refractive index nx of the cyclic polyolefin film from the transmission axis of the polarizer be within 1°, more desirably within 0.5°.

Transmittance of a single polarizing plate (Tt), of a parallel pair of polarizing plates (Tp), and of a crossed pair of polarizing plates (Tc) can be measured with UV3100PC (from Shimadzu Corp.). Measurements are made in a wavelength range of from 380 to 780 nm. Measurements were repeated 10 times for each of Tt, Tp, and Tc to obtain the respective averages.

A polarizing plate can be tested for durability using (1) two samples each prepared by superposing two polarizing plates crosswise or in parallel with their optical compensation films facing each other and (2) two samples (about 5 cm by 5 cm) each composed of a single polarizing plate bonded to a glass plate via a pressure-sensitive adhesive, with the optical compensation film side of the polarizer facing the glass plate. The transmittance of a single polarizing plate (Tt) is measured using each of the two glass-supported samples with its polarizing plate side facing a light source to obtain an average. Favorable polarizing performance of the polarizing plate is 40.5≦Tt≦45, 32≦Tp≦39.5, and Tc≦1.5, more favorably 41.0≦Tt≦44.5, 34≦Tp≦39.0, and Tc≦13. It is desirable that changes in polarizing performance before and after the durability test be minimized.

The cyclic polyolefin protective film is preferably subjected to any surface treatment for enhancing the adhesion to a polarizer. Suitable surface treatments include a glow discharge treatment, a UV irradiation treatment, a corona treatment, and a flame treatment. The glow discharge treatment as referred to here is a low-temperature plasma treatment under a low gas pressure or a plasma treatment under atmospheric pressure. For the details of the glow discharge treatment, reference can be made to U.S. Pat. Nos. 3,462,335, 3,761,299, and 4,072,769 and British Patent 891469 The method described in JP-T-59-556430 is also used, in which the gas composition of the discharge atmosphere is limited to only a gas species generated within a chamber when, after starting the discharge, a polyester support itself is subjected to a discharge treatment. The technique proposed in JP-B-60-16614 is effective as well, in which a vacuum glow discharge treatment is carried out at a film surface temperature of 80° C. to 180° C.

The glow discharge treatment is preferably carried out under conditions of a degree of vacuum of 0.5 to 3000 Pa, more preferably 2 to 300 Pa, a voltage of 500 to 5000 V, more preferably 500 to 3000 V, and a discharge frequency of from direct current to several thousands of megahertzs, more preferably 50 Hz to 20 MHz, even more preferably 1 KHz to 1 MHz. The discharge treatment intensity is preferably 0.01 to 5 kV·A·min/m², more preferably 0.15 to 1 kV·A·min/m².

UV irradiation treatment is also a preferred surface treatment. The UV treatment is performed by, for example, the methods described in JP-B-43-2603, JP-B-43-2604, and JP-B-45-3828. A mercury lamp can be used as a UV light source. A high pressure mercury lamp having a quartz tube that emits UV light having a wavelength of 180 to 380 nm is preferred. Unless it is problematical for the base film to have its surface temperature raised to around 150° C., a high pressure mercury lamp having a dominant wavelength of 365 nm can be used. Where the UV treatment should be at a lower temperature, a low pressure mercury lamp having a dominant wavelength of 254 nm is preferred. An ozoneless type high pressure and low pressure mercury lamp are also usable. The higher the radiation intensity, the higher the adhesion of the irradiated cyclic olefin resin film to a polarizer. Nevertheless, the film becomes colored and brittle with an increase in radiation intensity A recommended radiation intensity in using a high pressure mercury lamp having a main wavelength of 365 nm is 20 to 10000 mJ/cm², preferably 50 to 2000 mJ/cm², and that in using a low pressure mercury lamp is 100 to 10000 mJ/cm², preferably 300 to 1500 mJ/cm².

A corona discharge treatment is also preferred. A corona discharge treatment can be carried out in accordance with the methods described, e.g., in JP-B-39-12838, JP-A-47-19824, JP-A-48-28067, and JP-A-52-42114. Suitable commercially available corona treaters include the solid state corona treater manufactured by Pillar Technologies, Inc., a Lepel type corona discharge treater, and a Vetaphon type corona discharge treater. The treatment can be conducted in air at atmospheric pressure. The discharge voltage is preferably 5 to 40 kHz, more preferably 10 to 30 kHz. The waveform is preferably an alternating current sine wave. The gap clearance between the electrode and the dielectric roll is preferably 0.1 to 10 mm, more preferably 1.0 to 2.0 mm. The film is passed to a corona discharge treatment zone, wherein it is subjected to a corona discharge preferably of 0.3 to 0.4 kV·A·min/m², more preferably 0.34 to 0.38 kV·A·min/m², while passing over the upper part of a dielectric support roll.

A flame treatment is also a preferred surface treatment. While any of natural gas, liquefied propane gas, and city gas can be used, a mixing ratio with air is of importance because it is considered that the effect of a flame treatment is brought about by plasma containing active oxygen. The activity (temperature) of plasma, which is an important property of a flame, and how much of the oxygen is present are key points. These key points are governed by the gas to oxygen ratio. When the gas and oxygen react neither too much nor too little, a highest energy density is reached, producing high plasma activity. Specifically, a natural gas to air mixing ratio is preferably 1/6 to 1/10, more preferably 1/7 to 1/9; a liquefied propane gas to air mixing ratio is preferably 1/14 to 1/22, more preferably 1/16 to 1/19; and a city gas to air mixing ratio is preferably 1/2 to 1/8, more preferably 1/3 to 1/7. The amount of flame treatment is preferably 1 to 50 kcal/m², more preferably 3 to 20 kcal/m². The distance between the tip of the inner cone of the burner flame and the support is generally 3 to 7 cm and, more preferably, 4 to 6 cm. The shape of the nozzle of the burner includes a ribbon type by Flynn Burner Corp., a multi-hole type by the Wise Ltd., the U.S., ribbon type by Aerogen Inc, the U.K., a staggered multi-hole type by Kasuga Electric Co., Ltd., Japan, and a staggered multi-hole type by Koike Oxygen Co., Ltd., Japan. The back-up roll for holding the film is preferably made of a hollow cylinder roll that is water-cooled so that the treatment can be performed at a constant temperature between 20° and 50° C.

A preferred degree of the surface treatment, while dependent on the kind of the treatment and the kind of the cyclic polyolefin, is such that the resultant film surface may have a contact angle smaller than 50°, preferably 25° or greater and smaller than 45°, with pure water to exhibit good adhesion to a polarizer.

An adhesive containing a water soluble polymer is preferably used to bond the cyclic polyolefin protective film, preferably as surface treated, to a PVA polarizer. The water soluble polymer preferably includes a homo- or copolymer containing a unit of an ethylenically unsaturated monomer, such as N-vinylpyrrolidone, acrylic acid, methacrylic acid, maleic acid, β-hydroxyethyl acrylate, β-hydroxyethyl methacrylate, vinyl alcohol, methyl vinyl ether, vinyl acetate, acrylamide, methacrylamide, diacetonacrylamide or vinylimidazole; polyoxyethylene, polyoxypropylene, poly-2-methyloxazoline, methyl cellulose, hydroxyethyl cellulose, hydroxypropyl cellulose, and gelatin. PVA and gelatin are particularly preferred.

The properties desirable for PVA as an adhesive are the same as those described above which are desirable for the PVA used in the polarizer. In the present invention, it is preferred to use a crosslinking agent in combination with PVA. Examples of crosslinking agents suited to be combined with a PVA adhesive are boric acid, polyaldehydes, polyfunctional isocyanate compounds, and polyfunctional epoxy compounds, with boric acid being particularly preferred.

Gelatin that can be used as an adhesive includes lime processed gelatin, acid processed gelatin, enzyme processed gelatin, gelatin derivatives, and modified gelatin. Lime processed gelatin and acid processed gelatin are preferred of them. Crosslinking agents that can preferably be used in combination with gelatin include active halogen compounds, such as 2,4-dichloro-6-hydroxy-1,3,5-triazine and its sodium salt; active vinyl compounds, such as 1,3-bis(vinylsulfonyl)-2-propanol, 1,2-bis(vinylsulfonylacetamido)ethane, bis(vinylsulfonylmethyl)ether, and vinyl polymers having a vinylsulfonyl group in the side chain, N-carbamoylpyridinium salts, such as (1-morpholinocarbonyl-3-pyridinio)methanesulfonate; and haloamidinium salts, such as 1-(1-chloro-1-pyridinomethylene)pyrrolidinium 2-naphthalenesulfonate. The active halogen compounds and the active vinyl compounds are particularly preferred.

A preferred amount of the crosslinking agent to be added if needed is 0.1% or more and less than 40%, more preferably 0.5% or more and less than 30%, by weight based on the water soluble polymer in the adhesive. The adhesive is preferably applied to at least one of the protective film and a polarizer to form an adhesive layer, with which the two are bonded. More preferably, the adhesive is applied to the surface treated side of the protective film. The thickness of the adhesive layer is preferably 0.01 to 5 μm, more preferably 0.05 to 3 μm, on dry basis.

It is preferable to provide a functional layer, such as an antireflective layer, on the protective film provided on the opposite side of the polarizing plate to a liquid crystal cell. The polarizing plate of the invention preferably has (a) an antireflective layer composed of a light scattering sublayer and a low refractive index sublayer stacked in that order on one of the protective films or (b) an antireflective layer composed of a medium refractive index sublayer, a high refractive index sublayer, and a low refractive index sublayer stacked in that order on the protective film.

The antireflective layer composed of a light scattering sublayer and a low refractive index sublayer is described first. The light scattering sublayer preferably contains matte particles dispersed therein. The part of the light scattering sublayer where the matte particles are absent preferably has a refractive index of 1.50 to 2.00, while the low refractive index sublayer provided on the light scattering sublayer preferably has a refractive index of 1.20 to 1.49. The light scattering sublayer may have an antiglare function and a hard coat function. The light scattering sublayer may have a single layer structure or a multilayer structure composed of, for example, two to four subdivided layers.

The antireflective layer is preferably designed to have the following surface profile: Ra (roughness average) of 0.08 to 0.40 μm; Rz (10 point height parameter) of not more than 10 times the Ra; Sm (a mean spacing between peaks at the mean line) of 1 to 100 μm; a standard deviation of the peak heights measured from the deepest valley of 0.5 μm or less; a standard deviation of Sm of 20 μm or less; and the proportion of the slopes at 0° to 5° is 10% or more. The antireflective layer satisfying the above surface profile parameters achieves sufficient antiglare performance and a uniform matte appearance when observed with the naked eye. In order for reflected light to have a neutral tint, the reflected light on the antireflective layer preferably has an a* value of from −2 to 2 and a b* value of from −3 to 3 under a standard light source C, and a minimum to maximum refractive index ratio in a wavelength region of from 380 to 780 nm is preferably 0.5 to 0.99. It is also preferable for reducing yellowness of white display that the b* value of transmitted light be 0 to 3 under a standard light source C. Furthermore, when a brightness of the antireflective layer is measured with a grating of 40 μm by 120 μm placed between a planar light source and the antireflective layer, it is preferred that the brightness distribution have a standard deviation of 20 or less about the mean value. With this brightness distribution, the polarizing plate applied to a high definition panel has reduced glare.

The antireflective layer preferably has a specular reflectance of 2.5% or lower, a transmittance of 90% or higher, and a 60° gloss of 70% or less. With these optical characteristics, reflection of external light is suppressed to improve the display visibility. The specular reflectance is more preferably 1% or less, even more preferably 0.5% or less. To achieve no-glare and clarity of text when applied to high definition LCD panels, the antireflective layer preferably has a haze of 20% to 50%, an internal haze to total haze ratio of 0.3 to 1, a difference between the haze of the light scattering sublayer with no low refractive index sublayer formed thereon and the haze of the light scattering sublayer and the low refractive index sublayer formed thereon of 15% or less, a transmitted image clarity at an optical comb width of 0.5 mm of from 20% to 50%, and a transmittance ratio of vertically incident light/light incident at 2° deviation from the vertical direction of from 1.5 to 5.0.

The low refractive index sublayer that can be used to make the antireflective layer preferably has a refractive index of 1.20 to 1.49, still preferably 1.30 to 1.44. To ensure low refractivity, the low refractive index sublayer preferably satisfies formula:

(m/4)λ×0.7<n1d1<(m/4)λ×1.3

where m a positive odd number; n1 is the refractive index of the low refractive index sublayer, d1 is the thickness (nm) of the low refractive index sublayer; and λ is a wavelength ranging from 500 to 550 nm.

The low refractive index sublayer preferably contains a fluoropolymer as a low refractive index binder. The fluoropolymer is preferably a polymer crosslinked on application of heat or an ionizing radiation and having a dynamic frictional coefficient of 0.03 to 0.20, a contact angle with water of 90° to 120°, a pure water droplet sliding angle of 70° or smaller. Considering that a commercially available adhesive tape or label applied to the antireflective layer of an image display is desirably stripped off easily, the adhesive strength of the low refractive index sublayer to a commercially available pressure-sensitive adhesive tape is preferably 500 gf or less, more preferably 300 gf or less, even more preferably 100 gf or less. To secure scratch resistance, the low refractive index sublayer preferably has a surface hardness of 0.3 GPa or higher, still preferably 0.5 GPa or higher, measured with a microhardness meter.

The fluoropolymer includes one obtained by hydrolysis followed by dehydration condensation of a perfluoroalkyl-containing silane compound (e.g., heptadecafluoro-1,1,2,2-tetrahydrodecyl)triethoxysilane) and a fluorine-containing copolymer comprising a fluoromonomer unit and a monomer unit providing crosslinkability.

Examples of the fluoromonomer include fluoroolefins (e.g., fluoroethylene, vinylidene fluoride, tetrafluoroethylene, perfluorooctylethylene, hexafluoropropylene, and perfluoro-2,2-dimethyl-1,3-dioxole), partially or completely fluorinated alkyl ester derivatives of (meth)acrylic acid (e.g., Viscoat 6FM available from Osaka Organic Chemical Industry, Ltd. and M-2000 available from Daikin Industries, Ltd.), and partially or completely fluorinated vinyl ethers. Perfluoroolefins are preferred. Hexafluoropropylene is particularly preferred for its refractive index, solubility, transparency, and availability.

The units for providing crosslinkability include those derived from monomers having self-crosslinking functionality, such as glycidyl (meth)acrylate and glycidyl vinyl ether; those derived from monomers containing a carboxyl group, a hydroxyl group, an amino group, a sulfo group, etc., such as (meth)acrylic acid, methylol (meth)acrylate, hydroxyalkyl(meth)acrylate, allyl acrylate, hydroxyethyl vinyl ether, hydroxybutyl vinyl ether, maleic acid, and crotonic acid; and those resulting from incorporating a crosslinking functional group (e.g., (meth)acryloyl group) into the above-recited unit through polymer reaction (for example by causing acryl chloride to react on a hydroxyl group).

The fluorine-containing copolymer may further comprise, in addition to the fluoromonomer unit and the unit providing crosslinkability, a fluorine-free monomer unit to improve solvent solubility and transparency. Examples of such additional monomers include, but are not limited to, olefins (e.g., ethylene, propylene, isoprene, vinyl chloride and vinylidene chloride), acrylic esters (e.g., methyl acrylate, ethyl acrylate, and 2-ethylhexyl acrylate), methacrylic esters (e.g., methyl methacrylate, ethyl methacrylate, butyl methacrylate, and ethylene glycol dimethacrylate), styrene derivatives (e.g., styrene, divinylbenzene, vinyltoluene, and α-methylstyrene), vinyl ethers (e.g., methyl vinyl ether, ethyl vinyl ether, and cyclohexyl vinyl ether), vinyl esters (e.g., vinyl acetate, vinyl propionate, and vinyl cinnamate), acrylamides (e.g., N-t-butylacrylamide and N-cyclohexylacrylamide), methacrylamides, and acrylonitrile derivatives.

A curing agent may be added appropriately to the above-described polymer materials as proposed in JP-A-10-25388 and JP-A-10-147739.

The light scattering sublayer is provided usually for the purpose of endowing the film with light diffusing properties by surface scattering and/or internal scattering and hard coat properties to improve scratch resistance. Therefore, the light scattering sublayer comprises a binder for developing hard coat properties, matte particles for developing light scattering properties, and, if desired, an inorganic filler for increasing the refractive index, preventing shrinkage on crosslinking, and increasing the strength.

The light scattering sublayer preferably has a thickness of 1 to 10 μm, still preferably 1.2 to 6 μm, to secure hard coat properties and to prevent curling and embrittlement.

The binder of the light scattering sublayer is preferably a polymer having a saturated hydrocarbon main chain or a polyether main chain, more preferably a polymer having a saturated hydrocarbon main chain. The binder polymer preferably has a crosslinked structure. The binder polymer having a saturated hydrocarbon main chain is preferably a polymer of an ethylenically unsaturated monomer. The binder polymers having a saturated hydrocarbon main chain and a crosslinked structure preferably include homo- or copolymers of a monomer containing two or more ethylenically unsaturated groups. These monomers may have an aromatic ring or at least one atom selected from a halogen atom except fluorine, a sulfur atom, a phosphorus atom, and a nitrogen atom to provide a binder polymer with an increased refractive index.

Examples of the monomer containing two or more ethylenically unsaturated groups include esters of polyhydric alcohols and (meth)acrylic acid, such as ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, and polyester polyacrylate; ethylene oxide-modified products of the above esters; vinylbenzene and its derivatives, such as 1,4-divinylbenzene, 2-acryloylethyl 4-vinylbenzoate, and 1,4-divinylcyclohexanone, vinylsulfones (e.g., divinylsulfone); acrylamides (e.g., methylenebisacrylamide); and methacrylamides. These monomers may be used as a combination of two or more thereof.

The monomers affording a high refractive index include bis(4-methacryloylthiophenyl)sulfide, vinylnaphthalene, vinyl phenyl sulfide, and 4-methacryloxyphenyl-4′-methoxyphenyl thioether. These monomers may also be used as a combination of two or more thereof.

Polymerization of the ethylenically unsaturated group-containing monomer(s) can be conducted by, for example, applying an ionizing radiation or heat in the presence of a photo radical initiator or a thermal radical initiator. Accordingly, the light scattering sublayer is formed by applying a coating composition containing the ethylenically unsaturated group-containing monomer(s), a photo or thermal radical initiator, matte particles, and an inorganic filler to the protective film and curing the coating layer by radiation- or heat-induced polymerization. Known photo radical initiators and thermal radical initiators can be used.

The polymer having a polyether main chain is preferably a ring opening polymerization product of a polyfunctional epoxy compound. Ring opening polymerization of a polyfunctional epoxy compound is effected by applying an ionizing radiation or heat in the present of a photo-acid generator or a thermal acid generator. Accordingly, the light scattering sublayer can be formed by applying a coating composition containing the polyfunctional epoxy compound, a photo-acid generator or a thermal acid generator, matte particles, and an inorganic filler to the protective film and curing the coating layer by ionizing radiation- or heat-induced polymerization.

A monomer having a crosslinking functional group may be used in place of, or in addition to, the monomer having two or more ethylenically unsaturated groups to make a polymer containing the crosslinking functional group, which is then allowed to react to introduce a crosslinked structure into the binder polymer.

Examples of the crosslinking functional group include an isocyanate group, an epoxy group, an aziridine group, an oxazoline group, an aldehyde group, a carbonyl group, a hydrazine group, a carboxyl group, a methylol group, and an active methylene group. Also included in monomers capable of introducing a crosslinked structure are vinylsulfonic acids, acid anhydrides, cyanoacrylate derivatives, melamine, etherified methylols, esters, urethanes, and metal alkoxides such as tetramethoxysilane. A functional group that decomposes to develop crosslinkability, such as a blocked isocyanate group, is also useful. That is, the crosslinking functional group as referred to herein includes not only a ready-to-react one but a group that decomposes to become ready to crosslink. The binder polymer containing such a crosslinking functional group forms a crosslinked structure on being heated after the coating composition is applied.

The matte particles that are preferably used in the light scattering sublayer for imparting antiglare properties are greater than filler particles and usually have an average particle size of 1 to 10 μm, preferably 1.5 to 7.0 μm. The matte particles include inorganic compound particles and resin particles.

Examples of matte particles include particles of inorganic compounds, such as silica and titanium dioxide, and particles of resins, such as acrylic resins, crosslinked acrylic resins, polystyrene, crosslinked polystyrene, melamine resins, and benzoguanamine resins. Preferred of them are particles of crosslinked styrene, crosslinked acrylic resins, crosslinked acrylic styrene resins, and silica. The shape of the matte particles may be either spherical or irregular.

Two or more kinds of matte particles different in particle size may be used in combination. It is expected that larger particles contribute to non-glare while smaller particles serve for other optical characteristics.

It is particularly desirable that the matte particles have a mono-dispersed particle size distribution. In other words, it is preferred that the matte particles be as close to each other as possible in particle diameter. Particles whose size is 20% or more greater than the mean particle size being taken as coarse particles, the proportion of such coarse particles in all the particles is preferably 1% or smaller, more preferably 0.1% or smaller, even more preferably 0.01% or smaller. Matte particles with such a narrow size distribution are prepared by classifying particles as synthesized in a usual manner. An increased number of times of classification and/or an increased degree of classification result in a narrower and thus more desirable size distribution.

The matte particles are preferably used in an amount of 10 to 1000 mg/m², still preferably 100 to 700 g/m², in the light scattering sublayer.

The particle size distribution of the matte particles is measured with a Coulter counter. The measured distribution is converted to a number distribution.

In order to increase the refractive index of the light scattering sublayer, the light scattering sublayer preferably contains an oxide of at least one metal selected from titanium, zirconium, aluminum, indium, zinc, tin, and antimony having a mean particle size of 0.2 μm or less, more preferably 0.1 μm or less, even more preferably 0.06 μm or less, as an inorganic filler.

Where matte particles having a high refractive index are used, it is a preferred manipulation to use, as a filler, a silicon oxide largely different in refractive index from the matte particles thereby to somewhat reduce the refractive index of the light scattering sublayer to the contrary. The above-described preference for the particle size of inorganic fillers applies to the silicon oxide particles.

Examples of the inorganic fillers useful in the light scattering sublayer include TiO₂, ZrO₂, Al₂O₃, In₂O₃, ZnO, SnO₂, Sb₂O₃, ITO, and SiO₂. TiO₂ and ZrO₂ are preferred for increasing the refractive index. The inorganic filler may be surface treated with a silane coupling agent or a titan coupling agent. A surface treating agent having a functional group reactive with a binder species is preferably used.

The amount of the inorganic filler to be added is preferably 10% to 90%, more preferably 20% to 80%, even more preferably 30% to 75%, based on the total weight of the light scattering sublayer.

The filler with the recited particle size is small enough as compared with light wavelengths and therefore does not cause light scattering. A disperse system of such a filler in a binder polymer behaves as an optically homogeneous substance.

The refractive index of the bulk of a mixture of the binder and the inorganic filler in the light scattering sublayer is preferably 1.48 to 2.00, more preferably 1.50 to 1.80, which can be achieved by proper selection of the kinds and the ratio of the binder and the inorganic filler. The selection can easily be decided experimentally.

The coating composition for forming the light scattering sublayer preferably contains a fluorine-containing surface active agent and/or a silicone surface active agent to prevent coating unevenness, drying unevenness and spot defects thereby securing layer uniformity. A fluorine-containing surface active agent is particularly preferred for its capability of reducing coating unevenness, drying unevenness, spot defects, and like coating defects with a reduced amount of addition. By use of the surface active agent, coating defects can be reduced, which allows high-speed coating and eventually leads to increased productivity.

The antireflective layer having a medium refractive index sublayer, a high refractive index sublayer, and a low refractive index sublayer stacked in that order from the protective film side is then described.

The antireflective layer having at least a medium refractive index sublayer, a high refractive index sublayer, and a low refractive index sublayer (the outermost layer) stacked in that order from the protective film is preferably designed to satisfy the following relation: refractive index of the high refractive index sublayer>refractive index of the medium refractive index sublayer>refractive index of the protective film>refractive index of the low refractive index sublayer.

A hard coat sublayer may be provided between the protective film and the medium refractive index sublayer. Otherwise, a hard coat sublayer may be provided between the medium refractive index sublayer and the high refractive index sublayer. Antireflective layer designs that can be used in the invention are described, e.g., in JP-A-8-122504, JP-A-8-110401, JP-A-10-300902, JP-A-2002-243906, and JP-A-2002-111706. Each of the sublayers may have an additional function. For instance, the low refractive index sublayer may be designed to have stainproof properties, or the high refractive index sublayer may be designed to have antistatic properties. For the details, reference can be made to JP-A-10-206603 and JP-A-2002-243906.

The antireflective layer preferably has a haze of 5% or less, more preferably 3% or less, and a pencil hardness of H or higher, more preferably 2H or higher, even more preferably 3H or higher, measured in accordance with JIS K5400.

The medium refractive index sublayer and the high refractive index sublayer are each preferably a cured film containing at least ultrafine particles of an inorganic compound having a high refractive index and a mean particle size of 100 nm or smaller and a binder as a matrix.

Examples of the inorganic compound with a high refractive index include those having a refractive index of 1.65 or higher, preferably those having a refractive index of 1.9 or higher, such as oxides or complex oxides of Ti, Zn, Sb, Sn, Zr, Ce, Ta, La, In, etc.

Such ultrafine particles can be obtained by, for example, treating particles with a surface treating agent, such as a silane coupling agent (see JP-A-11-295503, JP-A-11-153703, and JP-A-2000-9908), an anionic compound or an organometallic coupling agent (see JP-A-2001-310432); forming a core/shell structure having a high refractive particle as a core (see JP-A-2001-166104), or using a specific dispersant (see JP-A-11-153703, U.S. Pat. No. 6,210,858, and JP-A-2002-2776069).

The matrix-forming binder includes known thermoplastic resins and known curing resins. The binder preferably includes a composition containing a polyfunctional compound having at least two, radical-polymerizable and/or cation-polymerizable groups and a composition containing an organometallic compound having a hydrolyzable group or a partial condensation product thereof, and a mixture of these compositions. Examples of these compositions are described in JP-A-2000-47004, JP-A-2001-315242, JP-A-2001-31871, and JP-A-2001-296401.

A cured film obtained from a composition containing a colloidal metal oxide and a metal alkoxide which is prepared by hydrolysis followed by condensation of the metal alkoxide is also a preferred matrix. The film is disclosed, e.g., in JP-A-2001-293818.

The high refractive index sublayer preferably has a refractive index of 1.70 to 2.20 and a thickness of 5 nm to 10 μm, more preferably 10 nm to 1 μm.

The refractive index of the medium refractive index sublayer is adjusted so as to be between the refractive index of the low refractive index sublayer (hereinafter recited) and that of the high refractive index sublayer. The medium refractive index sublayer preferably has a refractive index of 1.50 to 1.70 and a thickness of 5 nm to 10 μm, more preferably 10 nm to 1 μm.

The low refractive index sublayer, which is formed on the high refractive index sublayer, preferably has a refractive index of 1.20 to 1.55, more preferably 1.30 to 1.50.

The low refractive index sublayer is preferably designed to be a scratch-resistant and stainproof outermost sublayer. To impart slip properties to the surface is effective means for greatly improving scratch resistance, which can be achieved by applying a known thin film technique using silicone compounds or fluorine-containing compounds.

The fluorine-containing compounds preferably have a refractive index of 1.35 to 1.50, more preferably 1.36 to 1.47. The fluorine-containing compounds preferably include those containing a crosslinking or polymerizable functional group and having a fluorine content of 35% to 80% by weight. Examples of the fluorine-containing compounds are given in JP-A-9-222503, paras. [0018]-[0026], JP-A-11-38202, paras. [0019]-[0030], JP-A-2001-40284, paras. [0027]-[0028], and JP-A-2000-284102.

The silicone compounds are polysiloxane compounds preferably containing a curable functional group or a polymerizable functional group in the polymer chain thereof to form a crosslinked structure in a film. Examples include reactive silicones (Silaplane available from Chisso Corp.) and polysiloxanes having a silanol group at both terminals thereof (see JP-A-11-258403).

Crosslinking or polymerization of the fluorine-containing compound or silicone compound having a crosslinking or polymerizable group is preferably conducted by applying a coating composition for outermost sublayer containing the fluorine-containing compound or silicone compound, a polymerization initiator, a sensitizer, etc. to the high refractive index sublayer, etc. and applying light or heat to the coating layer either simultaneously with or after coating.

A sol-gel hardened film formed by condensation curing reaction between an organometallic compound, such as a silane coupling agent, and a silane coupling agent containing a specific fluorohydrocarbon group in the presence of a catalyst is also preferred. Examples of the latter silane coupling agent include polyfluoroalkyl-containing silane compounds or partial hydrolysis-condensation products thereof (e.g., the compounds described in JP-A-58-142958, JP-A-58-147483, JP-A-58-147484, JP-A-9-157582, and JP-A-11-106704) and silyl compounds having a perfluoroalkyl ether group, i.e., a fluorine-containing long chain (e.g., the compounds described in JP-A-2000-117902, JP-A-2001-48590, and JP-A-2002-53804).

In addition to the components described above, the low refractive index sublayer may contain other additives, such as a filler, a silane coupling agent, a slip agent, and a surface active agent. Examples of useful fillers include particles of inorganic compounds having a low refractive index and an average primary particle size of 1 to 150 nm, such as silicon dioxide (silica) and fluorine-containing compounds (e.g., magnesium fluoride, calcium fluoride, and barium fluoride), and fine organic particles described in JP-A-11-3820, paras. [0020]-[0038].

In case where the low refractive index sublayer is provided below an outermost sublayer, the low refractive index sublayer may be formed by vapor phase film formation processes, such as vacuum evaporation, sputtering, ion plating or plasma-assisted CVD. Wet coating methods are preferred for economical considerations nevertheless.

The low refractive index sublayer preferably has a thickness of 30 to 200 nm, more preferably 50 to 150 nm, even more preferably 60 to 120 nm.

In addition to the antireflective layer, the polarizing plate of the present invention can have a hard coat layer, a forward scattering layer, a primer layer, an antistatic layer, an undercoating layer, a protective layer, and the like.

The hard coat layer is provided on the protective film having the antireflective layer to give a physical strength to the protective film. It is preferably provided between a substrate (base film) and the high refractive index sublayer. The hard coat layer is preferably formed by crosslinking or polymerization of a photo- and/or heat-curing compound. The curing functional group of the curing compound is preferably a photopolymerizable functional group. An organometallic compound containing a hydrolyzable functional group is preferably an organic alkoxysilyl compound. Examples of useful compounds are the same as recited with respect to the high refractive index sublayer.

Examples of useful compositions for forming the hard coat layer are given in JP-A-2002-144913, JP-A-2000-9908, and WO00/46617.

The high refractive index sublayer can serve as a hard coat layer. In this case, it is preferable to form the hard coat layer by finely dispersing fine particles by using the technique described concerning the high refractive index sublayer.

The hard coat layer may contain particles having an average particle size of 0.2 to 10 μm to serve as an antiglare layer having an antiglare function.

The thickness of the hard coat layer can be appropriately designed depending on the purpose. The thickness of the hard coat layer preferably ranges from 0.2 to 10 μm, more preferably 0.5 to 7 μm.

The hard coat layer preferably has a pencil hardness of H or higher, more preferably 2H or higher, even more preferably 3H or higher, measured in accordance with JIS K5400. Furthermore, the hard coat layer preferably has as small Taber wear as possible in the Taber abrasion test specified in JIS K5400.

Where an antistatic layer is provided, it is desirable to impart electrical conductivity represented by a volume resistivity of 10⁻⁸ (Ωcm⁻³) or less. Although volume resistivity could be reduced to 10⁻⁸ (Ωcm⁻³) or less by using a hygroscopic substance, a water-soluble inorganic salt, a certain surface active agent, a cationic polymer, an anionic polymer, colloidal silica, etc., the volume resistivity of the resulting layer is heavily dependent on temperature and humidity and, as a result, the layer can fail to secure sufficient conductivity under a low humidity condition. Therefore, it is advisable to use a metal oxide as an antistatic layer material. Colored metal oxides are unfavorable because they would make the whole film colored. It is recommended to use colorless metal oxides mainly composed of at least one of Zn, Ti, Sn, Al, In, Si, Mg, Ba, Mo, W, and V. Examples of suitable metal oxides include ZnO, TiO₂, SnO₂, Al₂O₃, In₂O₃, SiO₂, MgO, BaO, MoO₃, V₂O₅, and complex oxides thereof. In particular, ZnO, TiO₂, and SnO₂ are preferred. The metal oxide may be doped with a hetero atom. Effective metal oxides doped with a hetero atom include ZnO doped with Al or In, SnO₂ doped with Sb, Nb or a halogen atom, and TiO₂ doped with Nb or Ta. A particulate or fibrous crystalline metal (e.g., titanium oxide) having the above-described metal oxide adhered thereto is also useful, as described in JP-B-59-6235. While volume resistivity and surface resistivity, being different physical properties, are not easily compared, a volume resistivity of 10⁻⁸ (Ωcm⁻³) or less will be secured when the antistatic layer has a surface resistivity of about 10⁻¹⁰ (Ω/square) or less, preferably 10⁻⁸ (Ω/square) or less. The surface resistivity of the antistatic layer should be measured while the antistatic layer is outermost. Namely, the surface resistivity measurement of the antistatic layer is taken in the course of the formation of a laminate structure.

The cyclic polyolefin film, the retardation film having the cyclic polyolefin film, and the polarizing plate having the cyclic polyolefin film according to the present invention are applicable to a wide range of display modes of LCDs. Proposed LCD display modes include TN (twisted nematic), IPS (in-plane switching), FLC (ferroelectric liquid crystal), AFLC (anti-ferroelectric liquid crystal) OCB (optically compensatory bend), STN (supper twisted nematic), VA (vertically aligned), and HAN (hybrid aligned nematic). Of these modes, OCB mode, TN mode, and VA mode are preferred for application of the present invention.

In a liquid crystal cell of OCB mode, rod-like liquid crystal molecules are aligned in a bend state (bent alignment) so that the molecules in one side of the cell and those in the other side are aligned substantially in the opposite direction (symmetrically). OCB mode liquid crystal cells are disclosed in U.S. Pat. Nos. 4,583,825 and 5,410,422. Since the alignment of the rod-like liquid crystal molecules is symmetrical at both sides of the cell, a bend-alignment cell has a self compensation function. This is why a bend alignment mode is called “optically compensatory bend” mode. LCDs of bend alignment mode have an advantage of improved response time.

In a liquid crystal cell of VA mode, rod-like liquid crystal molecules are aligned substantially vertically with no voltage applied. Liquid crystal cells of VA mode include (1) a liquid crystal cell of VA mode in a narrow sense of the term, in which rod-like liquid crystal molecules are substantially vertically aligned with no voltage applied and substantially horizontally aligned with voltage applied (see JP-A-2-176625), (2) a liquid crystal cell of MVA mode, in which the VA mode is modified to be multi-domain type so as to widen the viewing angle (described in SID97, Digest of Tech. Papers, 28 (1997), p. 845), (3) a liquid crystal cell of n-ASM mode, in which rod-like liquid crystal molecules are substantially vertically aligned with no voltage applied and aligned in twisted multi-domain alignment with voltage applied (described in Nippon Ekisho Toronkai, Digest of Tech. Papers (1998), pp. 58-59), and (4) a liquid crystal cell of SURVIVAL, mode (published in LCD international 98).

The VA mode LCD has a liquid crystal cell (VA mode cell) and a polarizing plate placed on each side of the cell. The liquid crystal cell holds a liquid crystal layer between two electrode plates.

In one embodiment of the transmissive LCD of the invention, the retardation film using the cyclic olefin resin film of the invention is placed between the liquid crystal cell and one of the polarizing plates or between the liquid crystal cell and each of the two polarizing plates.

In another embodiment of the transmission LCD according to the invention, the retardation film using the cyclic polyolefin film is used as a protective film of the polarizing plate, the protective film being provided between the liquid crystal cell and the polarizer. The retardation film can be used as a protective film of only one of the polarizing plates (the protective film positioned between the cell and the polarizer) or as a protective film of both of the two polarizing plates (the protective film positioned between the cell and each of the polarizers). When the retardation film is used in only one of the polarizing plates, it is preferably used as the liquid crystal cell side protective film of the backlight side polarizer. The polarizing plate is preferably adhered to the liquid crystal cell with the cyclic polyolefin film of the invention facing the VA mode liquid crystal cell. The protective film may be a cellulose acylate film ordinarily employed in the art. Cellulose acylate films having a thickness of 40 to 80 μm are preferred. Examples of commercially available cellulose acylate films that can be used as a protective film include, but are not limited to, KC4UX2M (thickness: 40 μm, available from Konica Opto Corp.), KC5UX (thickness: 60 μm; from Konica Opto Corp.) and TD80 (thickness: 80 μm; available from Fuji Photo Film Co., Ltd.).

An optical compensation film is used in OCB mode LCDs and TN mode LCDs for viewing angle enhancement. For application to OCB mode cells, an optical compensation film comprising an optically uniaxial or biaxial film and an optically anisotropic layer formed thereon is used. The optically anisotropic layer is formed by fixing discotic liquid crystal molecules in a hybrid alignment. For application to TN mode cells, an optical compensation film comprising an optically isotropic or a film having an optical axis in its thickness direction and an optically anisotropic layer formed thereon is used. The optically anisotropic layer is formed by fixing discotic liquid crystal molecules in a hybrid alignment. The cyclic polyolefin film of the invention is useful in the formation of the optical compensation films for the OCB mode cells and TN mode cells.

Preferred embodiments of the LCDs according to the invention are shown below.

A TN mode LCD in which at least one of the protective films of the polarizing plate has an in-plane retardation Re(630) of 15 nm or less and a thickness direction retardation Rth(630) of 40 to 120 nm both at 25° C. and 60% RH and has a discotic liquid crystal layer superposed thereon.

A VA mode LCD in which at least one of the protective films of the polarizing plate has an in-plane retardation Re(630) of 15 nm or less and a thickness direction retardation Rth(630) of 120 to 300 nm both at 25° C. and 60% RH and has a rod-like liquid crystal layer superposed thereon.

An OCB mode LCD in which at least one of the protective films has an in-plane retardation Re(630) of 30 to 70 nm and a thickness direction retardation Rth(630) of 120 to 300 nm both at 25° C. and 60% RH and has a discotic liquid crystal layer superposed thereon.

Where the cyclic olefin resin film of the invention is used as a retardation film, there are wide variety of needs, and the desired Re and Rth values vary depending on the kind of the retardation film. Generally, Re preferably ranges from 0 to 100 nm, and Rth preferably ranges from 40 to 400 nm.

Specifically, more preferred ranges for TN mode are 0 nm≦R≦20 nm and 40 nm≦Rth≦80 nm; and those for VA mode are 20 nm≦Re≦80 nm and 80 nm≦Rth≦400 nm. Even more preferred ranges for VA mode are 30 nm≦Re≦75 nm and 120 nm≦Rth≦250 nm. Taking into consideration the viewing angle dependency of color shift in a black display state and contrast in applications to VA mode cells, 50 nm≦Re≦75 nm and 180 nm≦Rth≦250 nm are particularly preferred where one retardation film is used for optical compensation, and 30 nm≦Re≦50 nm and 80 nm≦Rth≦140 nm are particularly preferred where two retardation films are used.

The optical characteristics of the cyclic polyolefin film of the invention can be controlled as designed by selecting the polymer structure, the kind and amount of additives, the stretch ratio, the residual volatile content at peeling, and the like.

In-plane retardation at a wavelength λ, Re(λ), is measured for the incidence of light having a wavelength of λnm in the direction normal to the film surface with a phase difference measurement system KOBRA. 21ADH (from Oji Scientific Instruments). Thickness direction retardation at a wavelength λ, Rth(λ), is calculated by KOBRA 21ADH based on retardation values measured in three directions: first is the Re(λ) obtained above, second is a retardation measured for light of a wavelength λnm incident in a direction tilted (rotated) by +40° with respect to the normal direction of the film around the in-plane slow axis, which is decided by KOBRA 21ADH, as an axis of tilt, and third is a retardation measured for light of a wavelength λ nm incident in a direction titled (rotated) by −40° with respect to the normal direction of the film surface around the in-plane slow axis as an axis of tilt. A hypothetical value of average refractive index as measured with Abbe refractometer and the thickness of the film are also needed for calculation. The measuring wavelength λ used here is 590 nm.

The present invention will now be illustrated in greater detail with reference to Examples, but it should be understood that the invention is not construed as being limited thereto. Unless otherwise noted, all the parts and percents are by weight.

### (1) Moisture Permeability

The water vapor transmission rate (abbreviated as WVTR) of a film was determined as follows. A sample having a measuring area of 70 mm in diameter was conditioned at 40° C. and 90% RH for 24 hours in a water vapor permeability tester (KK-709007 available from Toyo Seiki Seisaku-sho, Ltd.). The water content per unit area (g/m²) of the sample was measured in accordance with JIS Z0208. The WVTR was obtained from the difference between the weight before conditioning and the weight after conditioning.

### (2) Surface Properties

A film was observed with naked eye in transmitted or reflected light to inspect for a pattern, foreign matter, a scratch, and the like. A film having poor slip properties tends to undergo streaky wrinkling or skewing along the machine direction. A colorless and transparent film showing no visible irregularities was rated P (pass). A film with visible defects such as a pattern, foreign matter, and a scratch was rated F (fail).

### (3) In-Film Average Particle Size of Matting Agent

The particle sizes of 100 matting agent particles were measured on the surface of a film under SEM observation, and an average was calculated.

### SYNTHESIS EXAMPLE 1

### Synthesis of Cyclic Polyolefin P-1

In a reaction vessel were put 180 parts of purified toluene and 100 parts of norbornene-5-methanol acetate. To the mixture were added a solution of 0.04 parts of acetylacetonatopalladium (II) in 80 parts of toluene, 0.04 parts of tricyclohexylphosphine, and 0.20 parts of dimethylaluminum tetrakis(pentafluorophenyl)borate. The mixture was allowed to react at 90° C. for 18 hours while stirring. After completion of the reaction, the reaction mixture was poured into excess ethanol to precipitate the polymer produced, which was collected, purified, and dried in vacuo at 65° C. for 24 hours to yield polymer P-1.

### SYNTHESIS EXAMPLE 2

### Synthesis of Cyclic Polyolefin P-2

In a reaction vessel were put 330 parts of purified toluene, 100 parts of methyl norbornenecarboxylate, and 98 parts of butylnorbornene. To the mixture were added a solution of 0.04 parts of acetylacetonatopalladium (II), 0.04 parts of tricyclohexylphosphine, and a solution of 0.2 parts of dimethylaluminum tetrakis(pentafluorophenyl)borate in 25 parts of methylene chloride. The mixture was allowed to react at 90° C. for 18 hours while stirring. After completion of the reaction, the reaction mixture was poured into excess ethanol to precipitate the polymer produced, which was collected, purified, and dried in vacuo at 65° C. for 24 hours to give polymer P-2.

### SYNTHESIS EXAMPLE 3

### Synthesis of Cyclic Polyolefin P-3

In a reaction vessel were put 220 parts of purified toluene, 100 parts of methyl norbornenecarboxylate, and 27 parts of norbornene. To the mixture were added a solution of 0.03 parts of acetylacetonatopalladium (II) in 30 parts of toluene, 0.04 parts of tricyclohexylphosphine, and a solution of 0.15 parts of dimethylaluminum tetrakis(pentafluorophenyl)borate in 12 parts of methylene chloride. The mixture was allowed to react at 90° C. for 18 hours while stirring. After completion of the reaction, the reaction mixture was poured into excess ethanol to precipitate the polymer produced, which was collected, purified, and dried in vacuo at 65° C. for 24 hours to give polymer P-3.

### EXAMPLE 1

### Preparation of Cyclic Polyolefin Solution D-1

The following components were agitated in a mixing tank to dissolve. The solution was filtered through filter paper having an average pore size of 34 μm and a sintered metal filter having an average pore size of 10 μm.

| | |
|---|---|
| Cyclic polyolefin P-1 | 150 parts |
| Dichloromethane | 380 parts |
| Methanol | 70 parts |

### Preparation of Matting Agent Dispersion M-1

The following components were dispersed in a dispersing machine.

| | |
|---|---|
| Silicone particles having average primary particle size of 16 nm | 2 parts |
| (Aerosil R972 from Nippon Aerosil Co., Ltd.) | |
| Dichloromethane | 73 parts |
| Methanol | 10 parts |
| Cyclic polyolefin solution D-1 | 10 parts |

A hundred parts of cyclic polyolefin solution D-1 and 1.35 parts of matting agent dispersion M-1 were mixed up to prepare a film-forming dope.

The dope was cast on a belt casting machine. When the residual solvent content dropped to about 25%, the cast film was peeled off the belt, stretched in the width direction at a stretch ratio of 2% by means of a tenter, and dried by applying hot air of the temperature shown in Table 1 while taking care not to wrinkle the film. The film released from the tenter was dried at 120° to 140° C. while being conveyed on carrying rolls and wound into roll. The resulting film, designated film F-1, was measured and evaluated for thickness, surface properties, moisture permeability (WVTR), and in-film average particle size of the matting agent. The results obtained are shown in Table 1.

### EXAMPLE 2

A film (film F-2) was formed in the same manner as in Example 1, except for replacing cyclic polyolefin P-1 with cyclic polyolefin P-2. The resulting film, film F-2, was evaluated and measured in the same mariner as in Example 1. The results are shown in Table 1.

### EXAMPLE 3

### Preparation of Cyclic Polyolefin Solution D-2

The following components were agitated in a mixing tank to dissolve. The solution was filtered through filter paper having an average pore size of 34 μm and a sintered metal filter having an average pore size of 10 μm.

| | |
|---|---|
| Cyclic polyolefin P-3 | 150 parts |
| Dichloromethane | 380 parts |
| Methanol | 70 parts |

### Preparation of Matting Agent Dispersion M-2

The following components were dispersed in a dispersing machine.

| | |
|---|---|
| Silicone particles having average particle size of 2.0 μm | 2 parts |
| (Tospearl 120, form GE Toshiba Silicones Co., Ltd.) | |
| Dichloromethane | 73 parts |
| Methanol | 10 parts |
| Cyclic polyolefin solution D-2 | 10 parts |

A hundred parts of cyclic polyolefin solution D-2 and 1.35 parts of matting agent dispersion M-2 were mixed up to prepare a film-forming dope.

The dope was cast on a belt casting machine. When the residual solvent content dropped to about 25%, the cast film was peeled off the belt, stretched in the width direction at a stretch ratio of 2% by means of a tenter, and dried by applying hot air of the temperature shown in Table 1 while taking care not to wrinkle the film. The film released from the tenter was dried at 120° to 140° C. while being conveyed on carrying rolls and wound into roll. The resulting film, designated film F-3, was measured and evaluated in the same manner as in Example 1. The results obtained are shown in Table 1.

### COMPARATIVE EXAMPLE 1

Cyclic polyolefin solution D-1 was cast as a dope on a belt casting machine. The film was peeled off the belt at a residual solvent content of about 25%, stretched in the width direction at a stretch ratio of 2% by means of a tenter, and dried by applying hot air of the temperature shown in Table 1 while taking care not to wrinkle the film. The film had poor slip but was managed to be wound into roll after being trimmed 10% from each edge. The resulting film, designated film F-11, was measured and evaluated for thickness, surface properties, and moisture permeability (WVTR) in the same manner as in Example 1. The results obtained are shown in Table 1

### COMPARATIVE EXAMPLE 2

A commercially available norbornene-based thermoplastic film (ARTON Film, available from JSR Corp.), designated film F-12, was measured and evaluated for thickness, surface properties, and moisture permeability in the same manner as in Example 1. The results obtained are shown in Table 1.

### COMPARATIVE EXAMPLE 3

A commercially available cellulose triacetate film (Fuji Tack TD80U available from Fuji Photo Film Co, Ltd.), designated film F-13, was measured and evaluated in the same manner as in Example 1. The results obtained are shown in Table 1.

Each of the films F-1 to F-3 and F-11 to F-13 was examined for humidity dependency of the in-plane retardation (Re) in accordance with the following method. The results are shown in Table 1.

The film was conditioned at 25° C. and 10% RH and at 25° C. and 80% RH each for 2 hours and then measured for retardation for the incidence of light having a wavelength of 590 nm in the direction normal to the film surface with a phase difference measurement system KOBRA 21ADH (from Oji Scientific Instruments). The difference between the Re measured after conditioning at 10% RH and the Re measured after conditioning at 80% RH, i.e., Re(10%)-Re(80%), was obtained as a measure for humidity dependency of Re.

### EXAMPLE 4

A polarizer was prepared by doping a stretched PVA film with iodine.

Film F-1 prepared in Example 1 was subjected to a glow discharge treatment (radio frequency voltage of 3000 Hz, 4200 V was applied between upper and lower electrodes for 20 seconds) and bonded to both sides of the polarizer with a PVA adhesive and dried at 70° C. for 10 minutes to obtain polarizing plate A.

### EXAMPLE 5

Polarizing plate B was prepared in the same manner as in Example 4, except for replacing film F-1 with film F-2.

### EXAMPLE 6

Polarizing plate C was prepared in the same manner as in Example 4, except for replacing film F-1 with film F-3.

### COMPARATIVE EXAMPLE 4

Polarizing plate D was prepared in the same manner as in Example 4, except for replacing film F-1 with film F— 11.

### COMPARATIVE EXAMPLE 5

Polarizing plate E was prepared in the same manner as in Example 4, except for replacing film F-1 with film F-12 (Arton Film).

### COMPARATIVE EXAMPLE 6

Polarizing plate E was prepared in the same manner as in Example 4, except for replacing film F-1 with film F-13 (Fuji Tack TD80UF).

### EXAMPLE 7

Polarizing plate G was prepared in the same manner as in Example 4, except for replacing film F-1 on one side with film F-13 (Fuji Tack TD80UF).

Polarizing plates A to G prepared in Examples and Comparative Examples were evaluated for adhesion, water resistance, wet heat resistance, and durability in accordance with the following test methods. The results obtained are shown in Tables 2 and 3.

### (1) Adhesion

A 25 mm wide strip cut out of a polarizing plate was subjected to T-peel test in accordance with JIS K6854. The pulling speed was 100 mm/min.

### (2) Wet Heat Resistance

A polarizing plate trimmed to 50 mm×50 mm was immersed in hot water at 70° C. The time until whichever film came off completely was measured.

### (3) Durability

A polarizing plate was heated at 60° C. and at 95% RH for 1000 hours. The transmittance and degree of polarization (P) of the polarizing plate were measured before and after the heating to examine the changes due to the heating. The transmittance was measured on a single polarizing plate at 546.1 nm. The degree of polarization (P) was calculated from the transmittance of a parallel pair of polarizing plates (Tp) and of a crossed pair of polarizing plates (Tc) according to equation:

$$P ( \% ) = \sqrt{\frac{Tp - Tc}{Tp + Tc}} \times 100$$

TABLE 1

| | | | | | In-film | |
|---|---|---|---|---|---|---|
| | | | | | Average | |
| | | | | | Particle | |
| | | | | | Size of | |
| Sam- | Thick- | | WVTR | | Matting | |
| ple | ness | Surface | (g/m²/ | Re(10%)- | Agent | |
| No. | (μm) | Properties | 24 hrs) | Re(80%) | (μm) | Remark |
| F-1 | 80 | P | 380 | 0 | 0.2 | Invention |
| F-2 | 80 | P | 250 | 0 | 0.2 | Invention |
| F-3 | 90 | P | 220 | 0 | 2.0 | Invention |
| F-11 | 80 | F | 390 | 0 | — | Comparison |
| F-12 | 100 | P | 70 | 0 | — | Comparison |
| F-13 | 80 | P | 430 | 10 | 0.2 | Comparison |

TABLE 2

| | | Wet Heat | |
|---|---|---|---|
| Sample | Adhesive | Resistance | |
| No. | Force (N) | (min) | Remark |
| A | 110 | ≧120 | Invention |
| B | 90 | ≧120 | Invention |
| C | 90 | ≧120 | Invention |
| G | 120 | ≧120 | Invention |
| D | 80 | 90 | Comparison |
| E | 50 | 60 | Comparison |
| F | 140 | ≧120 | Comparison |

TABLE 3

| Sam- | Transmittance (%) | | | Polarization Degree (%) | | | |
|---|---|---|---|---|---|---|---|
| ple | Before | After | | Before | After | | |
| No. | Heating | Heating | ΔT | Heating | Heating | ΔP | Remark |
| A | 42.7 | 42.9 | 0.2 | 99.9 | 99.2 | −0.8 | Invention |
| D | 42.4 | 42.7 | 0.3 | 99.9 | 98.7 | −1.2 | Comparison |
| E | 42.6 | 43.0 | 0.4 | 99.9 | 98.6 | −1.3 | Comparison |

As is apparent from the results in Table 1, the cyclic olefin resin film of the invention possesses sufficient moisture permeability, which is advantageous for fabrication of a polarizing plate having the film, and yet the retardation of the film is not dependent on humidity, which proves the film extremely superior to conventional films.

As can be seen from the results in Table 2, the polarizing plate having the cyclic olefin resin film as a protective film is excellent in adhesion and water resistance. Use of the matting agent improves adhesion to provide a polarizing plate equal in adhesion and water resistance to conventional polarizing plates using a cellulose triacetate protective film.

As is seen from the results in Table 3, the polarizing plate having the cyclic olefin resin film as a protective film undergoes less change in transmittance in the wet heat test than the comparative films and exhibits a polarization degree of more than 99% even after the wet heat test, proving excellent in durability.

### EXAMPLE 8

### VA Mode LCD Assembly

A liquid crystal material having negative dielectric anisotropy (MLC6608, available from Merck) was dropwise injected and sealed into a pair of substrates spaced at a gap of 3.6 μm to make a liquid crystal cell having a liquid crystal layer between the substrates. The liquid crystal layer was designed to have a retardation (i.e., the product of the thickness d (μm) of the liquid crystal layer and the refractive index anisotropy Δn, i.e., Δn·d) of 300 nm. The liquid crystal material was vertically aligned. Polarizing plate B and A were bonded to the upper side (viewer's side) and the lower side (backlight side), respectively, of the VA mode cell via an adhesive in a crossed Nicols configuration such that the transmission axis of the upper side polarizing plate was in a vertical direction and that the transmission axis of the lower side polarizing plate was in a transverse direction.

The thus assembled LCD was observed for its display performance to find that neutral black display was realized in both the front direction and the viewing angle direction. The viewing angle (an angle giving a contrast ratio of 10 or more without gradient reversal in black display) of the LCD was measured with a contrast meter (EZ-Contrast 160D, manufactured by ELDIM) in eight scales from black (L1) to white (L8) display. The LCD had a wide viewing angle of ±80° C. in the horizontal direction.

This application is based on Japanese Patent application JP 2005-288704, filed Sep. 30, 2005, the entire content of which is hereby incorporated by reference, the same as if set forth at length.

1. A cyclic olefin resin film comprising a cyclic olefin resin and 0.03% to 1.0% by weight of particles and having a water vapor transmission rate of 200 to 400 g/m²/24 hrs at 40° C. and 90% RH, the particles having an average particle size of 3.0 μm or smaller in the film.

2. The cyclic olefin resin film according to claim 1, wherein the cyclic olefin resin comprises at least one cyclic olefin resin selected from the group consisting of:
(A-1) an addition copolymer comprising at least one repeating unit represented by formula (I): 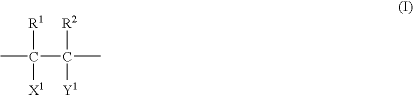
wherein X¹ and Y¹ each represent a hydrogen atom, a hydrocarbon group having 1 to 10 carbon atoms, a halogen atom, a halogen-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ or —(CH₂)ₙW; or X¹ and Y¹ are taken together to form (—CO)₂O or (—CO)₂NR¹⁵; R¹¹, R¹², R¹³, R¹⁴, and R¹⁵ each represent a hydrogen atom or a hydrocarbon group having 1 to 20 carbon atoms; Z represents a hydrocarbon group or a halogen-substituted hydrocarbon group; W represents SiR¹⁶ₚD₃₋ₚ; R¹⁶ represents a hydrocarbon group having 1 to 10 carbon atoms; D represents a halogen atom, —OCOR¹⁶ or —OR¹⁶; p represents an integer of 0 to 3; and n represents an integer of 0 to 10,
and at least one repeating unit represented by formula (II): 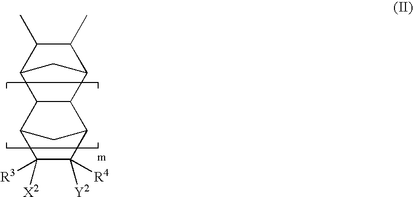
wherein m represents an integer of 0 to 4; R³ and R⁴ each represent a hydrogen atom or a hydrocarbon group having 1 to 10 carbon atoms; X² and Y² each represent a hydrogen atom, a hydrocarbon group having 1 to 10 carbon atoms, a halogen atom, a halogen-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ or —(CH₂)ₙW; or X² and Y² are taken together to form (—CO)₂O or (—CO)₂NR¹⁵, and R¹¹, R¹², R¹³, R¹⁴, R¹⁵, Z, W, and n are each as defined above;
(A-2) an addition homopolymer or copolymer comprising at least one repeating unit represented by formula (II), and
(A-3) a ring opening polymerization polymer or copolymer comprising at least one repeating unit represented by formula (III): 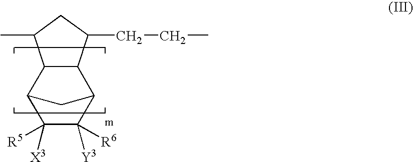
wherein m represents an integer of 0 to 4; R⁵ and R⁶ each represent a hydrogen atom or a hydrocarbon group having 1 to 10 carbon atoms; X³ and Y³ each represent a hydrogen atom, a hydrocarbon group having 1 to 10 carbon atoms, a halogen atom, a halogen-substituted hydrocarbon group having 1 to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ or —(CH₂)ₙW; or X³ and Y³ are taken together to form (—CO)₂O or (—CO)₂NR¹⁵; and R¹¹, R¹², R¹³, R¹⁴, R¹⁵, Z, W, and n are each as defined above.

3. The cyclic olefin resin film according to claim 1, wherein the particles are silicon dioxide particles or silicone particles.

4. A process for producing the cyclic olefin resin film of claim 1, comprising the steps of
casting a dope comprising a cyclic olefin resin and fine particles on a support,
peeling the cast film from the support, and
drying the cast film.

5. The process according to claim 4, further comprising the step of stretching the cast film peeled off the support.

6. A polarizing plate comprising a polarizer and a protective film on both sides of the polarizer, at least one of the protective film on one side and the protective film on the other side of the polarizer is the cyclic olefin resin film of claim 1.

7. A liquid crystal display comprising at least one polarizing plate, the at least one polarizing plate being the polarizing plate of claim 6.

8. The liquid crystal display according to claim 7, which is a VA mode liquid crystal display.
